(19) United States
(12) Patent Application Publication
(10) Pub. No.: US 2017/0236284 A1
(43) Pub. Date: Aug. 17, 2017

(54) REGISTRATION OF AERIAL IMAGERY TO VECTOR ROAD MAPS WITH ON-ROAD VEHICULAR DETECTION AND TRACKING

(71) Applicants: Ahmed S. Elliethy, (US); Gaurav Sharma, (US)

(72) Inventors: Ahmed S. Elliethy, Rochester, NY (US); Gaurav Sharma, Webster, NY (US)

(73) Assignee: University of Rochester, Rochester, NY (US)

(21) Appl. No.: 15/076,309

(22) Filed: Mar. 21, 2016

Related U.S. Application Data
(60) Provisional application No. 62/295,068, filed on Feb. 13, 2016.

(51) Int. Cl. G06T 7/00

(52) U.S. Cl. CPC G06T 7/0028; G06T 7/0036; G06T 2207/30241; G06T 2207/10004; G06T 2207/10032; G06T 2207/30184; G06T 2207/30236

(57) ABSTRACT

Methods for aligning images captured by aerial imaging platforms with a road network described by geo-referenced data, including the steps of: (a) identifying locations of moving vehicles in at least one image; (b) estimating a coordinate transformation that aligns the identified locations with the road network described by the geo-referenced data; and (c) outputting the estimated coordinate transformation or applying the estimated coordinate transformation to at least one image to align the image(s) with the road network described by the geo-referenced data. The methods may classify post-transformation detection as on-road detections or non-on-road detections to improve accuracy and synergistically use transformations and proximity to the road network to improve vehicle detection. The methods may identify vehicle trajectories to further improve accuracy and synergistically use transformations and proximity to the road network to improve estimates of vehicle trajectories.

This application claims the benefit of U.S. Provisional Application No. 62/295,068, filed Feb. 13, 2016, the disclosure of which is incorporated herein by reference in its entirety. This application also includes references to various publications, set forth in bracketed numbers and identified in a references section, each of which is incorporated herein by reference in its entirety for the purposes identified in the citing material.

### TECHNICAL FIELD

The present disclosure relates to the registration of vector road map data with high altitude area imagery data and, in particular, to the use of vehicular movement information obtained through wide area motion imagery (WAMI) in the registration of vector road map data with WAMI datasets, in vehicular detection and identification using registered WAMI datasets, and in vehicular tracking using registered WAMI datasets.

### BACKGROUND

Recent technological advances have made a number of airborne platforms available for capturing imagery [1, 2]. One area of emerging interest is Wide Area Motion Imagery (WAMI), where images at temporal rates of 1-2 frames per-second are captured for relatively large areas that span substantial parts of a city with sufficient spatial detail to resolve individual vehicles [3]. WAMI platforms are becoming increasingly prevalent and the low-frame-rate video that they generate is suitable for use in large scale visual data analytics. The effectiveness of such analytics can be enhanced by combining WAMI datasets with alternative sources of rich geo-spatial information such as road maps.

### SUMMARY

A first aspect is method for aligning one or more images, captured by a camera on an aerial imaging platform, with a road network, described by geo-referenced data as binary images, vector data, or other representation. The first aspect comprises the steps of: (a) identifying locations of moving vehicles in at least one of the images; (b) estimating a coordinate transformation that aligns the identified locations with the road network described by the geo-referenced data; and (c) outputting the estimated coordinate transformation or applying the estimated coordinate transformation to at least one of the images to align the image(s) with the road network described by the geo-referenced data.

A second aspect is a method for aligning a series of images, captured by a camera on an aerial imaging platform, with a road network described by geo-referenced vector data. The second aspect comprises the steps of: (a) aligning the series of images to the road network described by geo-referenced vector data by estimating a series of coordinate transformations that align moving vehicle locations detected within the series of images with the road network; (b) applying the estimated coordinate transformations to the detected moving vehicle locations; (c) classifying the post-transformation detected moving vehicle locations, as on-road vehicle locations or non-on-road vehicle locations, by comparing the post-transformation detected moving vehicle locations to the road network; and (d) realigning the series of images to the road network by estimating a series of coordinate transformations that align the on-road-vehicle-location-classified locations with the road network described by geo-referenced vector data.

A third aspect is a method for aligning a series of images, captured by a camera on an aerial imaging platform, with a road map describing a road network via geo-referenced data, as binary images, vector data, or other representation, and for tracking on-road moving vehicles in the imaged scene, the method comprising: (a) estimating an initial set of moving vehicle detections corresponding to putative vehicle locations in the imaged scene; (b) estimating an initial set of parameters specifying an alignment between the road map and the series of images; and (c) iteratively performing, at least once, steps for estimating updated vehicle trajectories and an updated transformation. The iteratively performed steps include: (d) estimating identifiable parts of trajectories of one or more on-road vehicles by associating members a temporal sequence of locations, corresponding to vehicle detections not yet assigned to an existing reliable trajectory, with other such members or with an existing reliable trajectory based upon an alignment to the road map specified by the set of parameters; (e) selecting estimated trajectories based upon at least one of: proximity to a road in the road map; co-directionality with a road in the road map; and speed of travel; whereupon the selected estimated trajectories are added to existing reliable trajectories; and (f) updating the set of parameters to improve a measure of coincidence between the existing reliable trajectories and the roads in the roadmap, wherein the measure of coincidence is based on estimating the proximity of the existing reliable vehicle trajectories to roads in the road map and, optionally, co-directionality with roads in the road map.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is shows an exemplary alignment between a WAMI video frame and a geo-registered road network for (a) an alignment determined using only encoded meta-data and (b) an alignment determined using vehicle movement detected within the scene.

FIG. 2 is a schematic block diagram of a first algorithm.

FIG. 3 is a schematic diagram of a compensated frame-to-frame difference calculation.

FIG. 4 is a schematic diagram of a coordinate transformation from a camera-native Cartesian coordinate system to a geo-referenced Cartesian coordinate system.

FIG. 5 is an exemplary WAMI video frame indicating the region shown in FIG. 6.

FIG. 6 shows alignments between the WAMI video frame of FIG. 5 and a geo-registered road network, within the region indicated in FIG. 5, obtained using (a) the MBA method (b) the SBA method and (c) a disclosed first algorithm.

FIG. 7 is an exemplary WAMI video frame indicating the region shown in FIG. 8.

FIG. 8 shows alignments between the WAMI video frame of FIG. 7 and a geo-registered road network, within the region indicated in FIG. 7, obtained using (a) the MBA method (b) the SBA method and (c) the disclosed first algorithm.

FIG. 9 is a schematic diagram illustrating how true positive (TP) regions, false positive (FP) regions, and false negative (FN) regions are determined for the calculation of a precision-recall metric.

FIG. 10 is a precision-recall plot for alignments determined for an exemplary WAMI video frame.

FIG. 11 is a relative positional accuracy plot for alignments determined for exemplary WAMI video frames.

FIG. 12 is a schematic block diagram of a second algorithm.

FIG. 13 is a schematic diagram of a coordinate transformation from a camera-native Cartesian coordinate system to a geo-referenced Cartesian coordinate system

FIG. 14 is a summary diagram of the second algorithm.

FIG. 15 is an exemplary visual spectrum WAMI video frame indicating the region shown in FIG. 16.

FIG. 16 shows alignments between the WAMI video frame of FIG. 15 and a geo-registered road network, within the region indicated in FIG. 15, obtained using (a) the MBA method (b) the SBA method and (c) the disclosed second algorithm (Alg2).

FIG. 17 is an exemplary infra-red spectrum WAMI video frame indicating the regions shown in FIG. 18.

FIG. 18 shows alignments between the WAMI video frame of FIG. 17 and a geo-registered road network, within the regions indicated in FIG. 17, obtained using (a) the MBA method (b) the SBA method and (c) the disclosed second algorithm (Alg2).

FIG. 19 is an exemplary infra-red spectrum WAMI video frame indicating the region shown in FIG. 20.

FIG. 20 shows alignments between the WAMI video frame of FIG. 19 and a geo-registered road network, within the region indicated in FIG. 19, obtained using (a) the MBA method (b) the SBA method and (c) the disclosed second algorithm (Alg2).

FIG. 21 is a precision-recall plot for alignments determined for an exemplary test area within a WAMI video frame (test area 1 of Table 2).

FIG. 22 is a relative positional accuracy plot for alignments determined for an exemplary WAMI video frame (test area 1 of Table 2).

FIG. 23 is a relative positional accuracy plot for alignments determined for an exemplary WAMI video frame (test area 2 of Table 2).

FIG. 24 is a schematic illustration of a joint vehicle tracking and road network alignment scenario highlighting four vehicles, twelve vehicle detections in three illustrative video frames, and four trajectories determined after transformation into the common reference frame of the road network.

FIG. 25A is a schematic block diagram of a moving vehicle identification step for a third algorithm.

FIG. 25B is a schematic block diagram of the third algorithm

FIG. 26 is a summary diagram of the third algorithm.

FIG. 27A is a visual comparison of a ground truth road network to an alignment determined through the MBA method.

FIG. 27B is a visual comparison of a ground truth road network to an alignment determined through the SBA method.

FIG. 27C is a visual comparison of a ground truth road network to an alignment determined through the third algorithm.

### DETAILED DESCRIPTION

This disclosure focuses upon the registration of vector road map data with aerial imagery data, such as WAMI video frames, and includes novel algorithms that exploit vehicular motion for accurate and computationally efficient alignment of the respective data. Registering vector road map data with aerial imagery data leads to a rich source of geo-spatial information that can be used for many applications. One application of interest is moving vehicle detection and tracking. By registering the road network to aerial imagery, one can easily filter out false detections that occur off the road network. Another application is the detection and tracking of suspicious off-road traffic. These applications depend upon accurate alignments between aerial imagery and the road network, which is typically represented in a vector format that describes the roads mathematically as lines or curves connecting a series of geo-registered points. Such alignment of the aerial imagery with a geo-registered road network also directly provides an alignment between the aerial image and any prior geo-registered image.

In general, successive WAMI video frames can be related by both global and local motions. Global motion arises from camera movement due to movement of the aerial platform, and can be parameterized as a homography between spatial coordinates for successive frames under the assumption that the captured scene is planar. Local motion arises due to local movement of objects within the captured scene. Local motion in WAMI datasets for urban areas is dominated by vehicle movements on the road network within the captured scene. Those movements can be exploited to develop an effective registration scheme for aligning vector road map data with WAMI video frames.

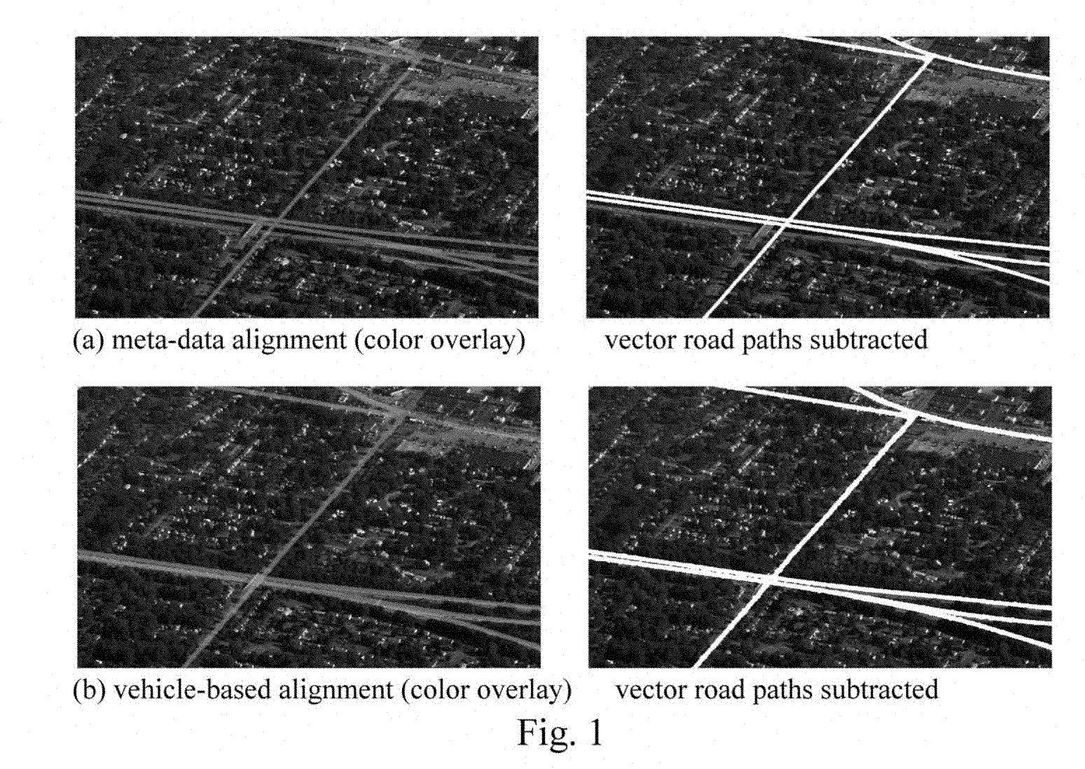

WAMI video frames are usually captured from a platform equipped with both Global Positioning System (GPS) and Inertial Navigation System (INS) equipment so as to provide location and orientation information that is usually stored with the video frames as meta-data. This meta-data can be used to align a road network extracted from an external source such as a Geographic Information System (GIS). However, as illustrated in FIG. 1(a), the accuracy of the meta-data can be limited and usually provides only an approximate alignment.

Registering an aerial image directly with geo-referenced vector road map data is a challenging task because of differences in the nature of the data in the two formats: in one case the data consists of image pixel values whereas in the other it comprises a series of lines/curves connecting a series of geo-registered points. Because of the inherent differences in the data formats, one cannot readily define low/mid-level features that are invariant to the representations and thus useful for registration using conventional feature detectors, such as SIFT (Scale-Invariant Feature Transform) [4], that find corresponding points in images. For static aerial imagery, the process of aligning road maps to aerial imagery is generally referred to as “conflating” or “conflation.” In general, conflation fuses spatial representations from multiple data sources to obtain a new superior representation. In prior applications [5-7], vector road map data has been aligned with aerial imagery data by matching road intersection points in both representations. The crucial technique used in those applications is the detection of road intersections within the aerial image. With the availability of hyper-spectral aerial imagery, spectral properties and contextual analysis may be used [5] to detect road intersections in the captured scene. However, road segmentation is not robust for different natural scenes, especially when roads are obscured by shadows from trees and nearby buildings. In other prior applications [6], a Bayes classifier has been used to classify pixels as on-road or off-road, and then localized template matching has been used to detect road intersections. However, to get a reasonable accuracy with a Bayes classifier, a large number of manually labeled training pixels are required for each data set. In yet other prior applications [7], corner detection has been used to detect road intersections. However, this technique is not reliable, especially in high resolution aerial images that contain enough wide roads that corner detection fails.

Registration of (non-static) WAMI video frames to geo-referenced vector road map data has received less attention. Some prior attempts to overcome the problem posed by the fundamentally different modalities of WAMI and vector datasets have used an auxiliary geo-referenced image that is already aligned with the vector road map data. The aerial video frames are then aligned to the auxiliary geo-referenced image by using conventional image feature matching methods. For example, for the purpose of vehicular tracking, video frames have been geo-registered with a geo-referenced image and then a GIS database used for road network extraction [8]. The road network may then be used to regularize the matching of current moving vehicle detections to previous existing vehicular tracks. In an alternative approach that relies on 3D geometry, SIFT has been used to detect correspondences between ground features from a small footprint aerial video frames and a geo-referenced image [9]. This geo-registration helps to estimate the camera pose and depth map for each video frame, and the depth map is used to segment the scene into building, foliage, and roads using a multi-cue segmentation framework. The process is computationally intensive and the use of the auxiliary geo-referenced image is still plagued by problems with the identification of corresponding feature points because of illumination changes, different capturing times, severe view point change in aerial imagery, and occlusion. State of the art feature point detectors and descriptors, such as SIFT (Scale-Invariant Feature Transform) [4] and SURF (Speeded Up Robust Features) [10], often find many spurious matches that cause robust estimators, such as RANSAC [11], to fail when estimating a homography. Also, these methods cannot work directly if the aerial video frames have a different modality (infra-red imagery, for example) than the geo-referenced image. Last, but not least, a single homography represents the relation between two images when the scene is close to planar [12]. In WAMI datasets, aerial video frames are usually taken from an oblique camera array to cover a large ground area from a moderate height, and the scene usually contains non-ground objects such as building, trees, and foliage. Thus the planar assumption does not necessarily hold across the entire imagery, although it is not unreasonable for the road network itself.

Efforts have been made to use WAMI datasets in vehicular tracking. The majority of approaches adopt a tracking-by-detection framework, and attempt to associate frame-by-frame detections so that individual vehicles are consistently identified over the entire set of aerial image frames. In [13], detections in successive WAMI video frames are associated based upon a context similarity measure, and in [14] a similar context similarity scheme is proposed to handle more complex cases. In [8], joint probabilistic graph matching is used for association. Due to limited vehicle appearance, these methods are prone to ID switches, since some characteristics (speed, direction, etc.) for tracked vehicles are inferred from the first few frames of imagery, which can result in ambiguous or incorrect associations in subsequent frames. Related efforts for tracking pedestrians in CCTV-like video approach the association problem globally over an entire set of video frames [15-17]. These approaches can efficiently obtain solutions within reasonable times, but do not scale to WAMI because of the extremely large number of vehicles appearing within the urban scenes captured in WAMI datasets. Additionally, the latter approaches are often designed for full motion video at 30 frames per second and thus do not directly translate to the low frame rate video of typical WAMI systems and datasets.

We disclose algorithms that accurately align vector road map data to aerial video frames by detecting the locations of moving vehicles and aligning the detected vehicle locations or trajectories with the road network of the vector road map data. The vehicle locations are detected by traditional vehicle detection techniques such as background subtraction or compensated frame-to-frame difference, and optionally associated over a time window of video frames to form trajectories. When using vehicle detections only, the video frames are aligned to the vector road map data by estimating projective transformation parameters that, after appropriate application of the transformation, minimize a “chamfer distance”—a metric that is a function of distance from detected vehicle locations or trajectories to corresponding nearest points on the road network—that can be efficiently computed via the distance transform [18]. Vehicle trajectories can provide additional direction information that can be exploited along with directionality information for the road network by using a directional chamfer distance as metric. These chamfer distances serve as an ideal quantitative metric for the degree of misalignment because they do not require any feature correspondences or computation of displaced frame differences, both of which are inappropriate because of the different modalities of the data. By exploiting moving vehicle detections/trajectories and using the vector road network, we implicitly transfer both the aerial imagery and the geo-referenced vector road map data to representations that can be easily matched. In other words, unlike traditional methods, the disclosed algorithms do not directly estimate any feature correspondence between video frames and vector road map data. For example, the first and second algorithms may convert the vector road map data to a binary image prior to alignment, and thus can also readily work with binary images of the road network. Other representations of the road network could be converted into a binary image and similarly used. Both algorithms may exploit the efficiency posed by the binary image representation of the roads by employing appropriate distance transforms. It should be appreciated that the disclosed algorithms may use a binary image representation or vector data equally readily, even though the subsequent descriptions are otherwise specific to one representation or the other. The third algorithm requires an extra level of information, which is road directionality within the road network. This information is typically available in GIS systems and vector representations. However, when using binary image representations of the road network, directionality information may be obtained from any GIS data source by exploiting the geo-referenced nature of the image representation.

### First Registration Algorithm

A first algorithm essentially aligns two binary images, representing moving vehicle detections and a network of road lines derived from the vector road map data, respectively, thereby providing a more accurate and robust alignment. A sample result from the algorithm is shown in FIG. 1(b). By comparing FIGS. 1(a) and 1(b), it can be appreciated that the method provides an accurate alignment to the road network. The principal assumption of the algorithm is that the scene contains a forked road network, which is reasonable for WAMI datasets which cover a city scale ground area within each video frame. The algorithm does not depend on the aerial camera sensor type; for example, it can be used directly with aerial infra-red camera imagery.

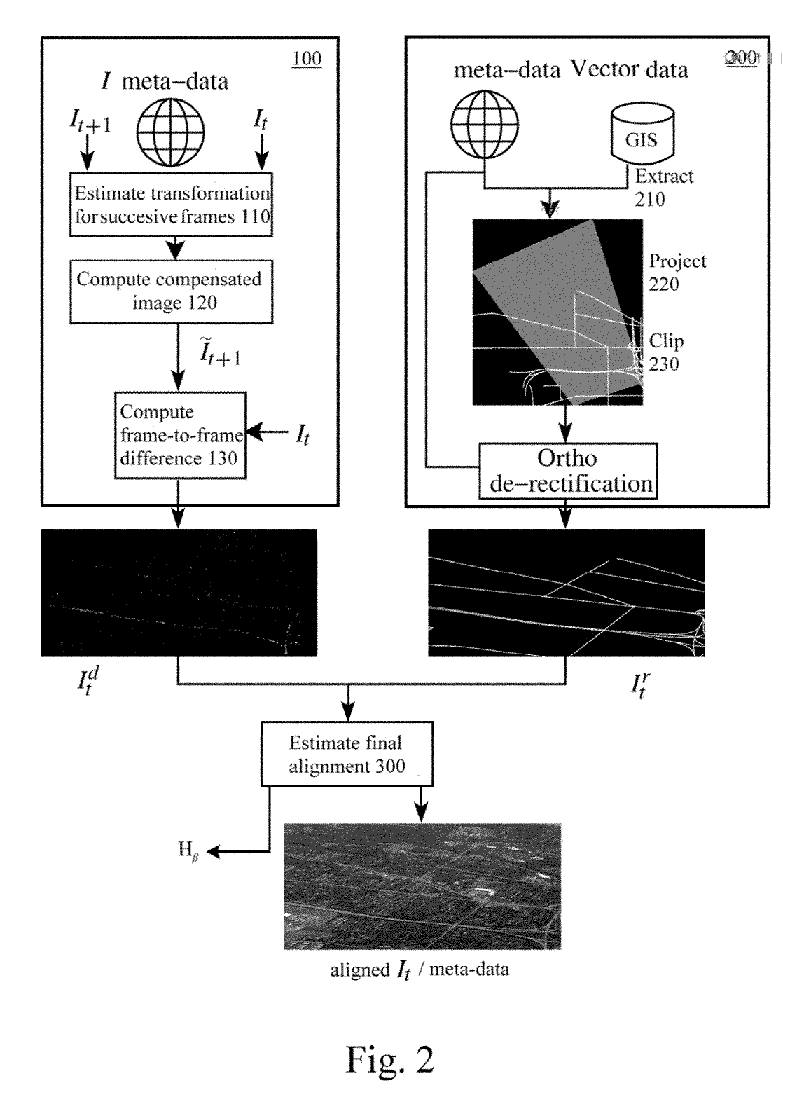

A high level overview of the first algorithm is shown in block-diagram format in FIG. 2, along with illustrative example images. The algorithm consists of three major parts. First, the algorithm may perform a frame-to-frame registration 100 to align temporally adjacent WAMI video frames, denoted by Iₜ and Iₜ₊₁, into a common reference frame 120 and to identify moving vehicle locations by computing frame-to-frame differences [19] between those frames 130. The regions of significant magnitude in such frame-to-frame differences predominantly correspond to the locations of moving vehicles. Then the algorithm may combine the meta-data associated with Iₜ with vector road map data to generate a road network coarsely aligned with Iₜ 200. Then the algorithm estimates a final alignment between the road network and moving vehicle detections by minimizing the chamfer distance [18] between them 300, which corresponds to minimizing the sum of the squared distances between each moving vehicle detection and a corresponding nearest point on the road network. This sum of squared minimum distances is one of several alternative possibilities that can be used for the chamfer distance. Other measures, for instance, absolute distances or other monotonic functions of distance, can also be readily utilized and should be understood to be within the scope of the term “chamfer distance” unless otherwise specified. The algorithm provides the optimal parameters for an estimated coordinate transformation that aligns the aerial imagery to the road network. This coordinate transformation can be applied to the aerial imagery to align it to the vector road map data or vice versa. This estimated final alignment may be output to control a computer system, such as a traffic analysis system or vehicle tracking system, and enable the system to more accurately geo-reference aerial imagery, or may generate and output an aligned dataset containing video frames and meta-data (such as geographical coordinates for the corners associated with the video frame) derived from the final estimated alignment. This enables additional information from rich sources of GIS information to be exploited in further applications of the imagery.

Frame-to-frame registration and alignment 100 is a prerequisite to obtaining moving vehicle detections through frame-to-frame differences. A projective transformation [12] may be used for alignment, where the 2D point p₁=(x, y) in the input image is mapped to the 2D point p₂=(u, v) in the target image by the transformations:

$$u = \frac{{h}_{1} x + {h}_{2} y + {h}_{3}}{{h}_{7} x + {h}_{8} y + 1} , v = \frac{{h}_{4} x + {h}_{5} y + {h}_{6}}{{h}_{7} x + {h}_{8} y + 1} , \qquad Equation ( 1 )$$

with the transformation specified by the parameter vector β=[h₁; . . . , h₈]^{T}. The mapping can be equivalently represented as the matrix multiplication:

$$( \begin{matrix}u \\ v \\ 1\end{matrix} ) = {H}_{β} ( \begin{matrix}x \\ y \\ 1\end{matrix} ) = ( \begin{matrix}{h}_{1} & {h}_{2} & {h}_{3} \\ {h}_{4} & {h}_{5} & {h}_{6} \\ {h}_{7} & {h}_{8} & 1\end{matrix} ) ( \begin{matrix}x \\ y \\ 1\end{matrix} ) , \qquad Equation ( 1 a )$$

where [x, y, 1]^{T} and [u, v, 1]^{T} are the homogeneous coordinate representation of p₁ and p₂, respectively. The projective transformation has 8 degrees of freedom and the only invariant property of the transform is the cross ratio of any four collinear points [12].

The first algorithm may estimate the projective transformation that aligns successive frames 110, e.g., Iₜ and Iₜ₊₁, then compute a compensated image in a common reference frame 120, e.g., an image Ĩₜ₊₁ that is aligned with Iₜ. Then the algorithm may compute the displaced frame-to-frame difference between them 130, e.g., local differences between the compensated Ĩₜ₊₁ and Iₜ. Specifically, the algorithm may compute the binary image:

$${I}_{t}^{d} ( x ) = \{ \begin{matrix}1 , & if \vert {I}_{t} ( x ) - {\tilde{I}}_{t + 1} ( x ) \vert \geq τ \\ 0 , & otherwise\end{matrix} , \qquad Equation ( 2 )$$

where τ may be a predetermined threshold value that trades-off the detection of true regions of local motion versus inevitable noise and other sources of variation in the images. The detection points above the predetermined threshold (if a threshold is used) are assumed to correspond to the locations of moving on-road vehicles.

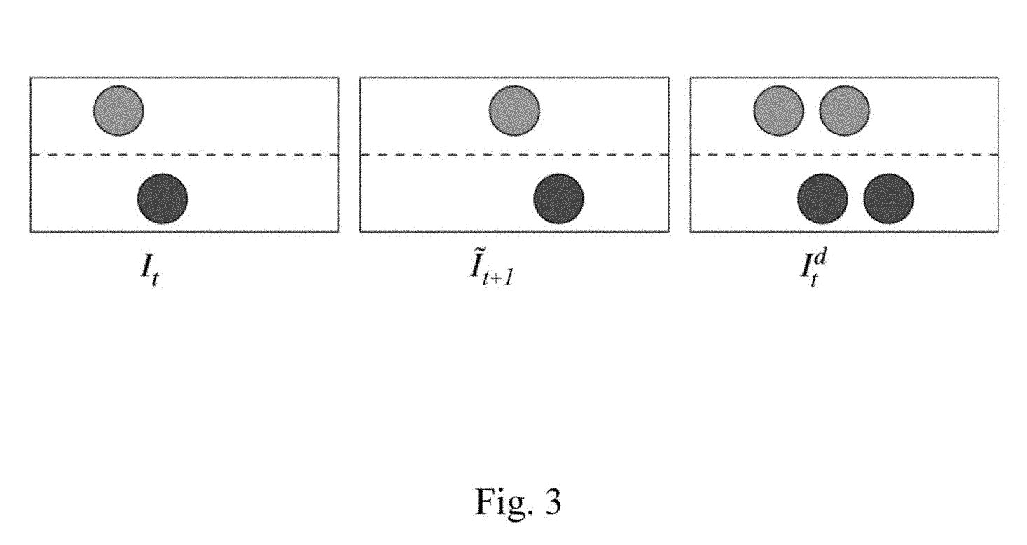

As illustrated in FIG. 3, each moving vehicle tends to result in two separate blobs in Iₜ^{d} due to the low frame rate of the WAMI video frames. One of those blobs could be eliminated using three frame difference [8]. However, because the two blobs still presumably reside on the road network, they both can be used to advantage. In other words, Iₜ^{d} contains blobs at vehicle locations in both the preceding frame and the current compensated video frame. The total number of such blobs approximates two times the number of vehicles in the scene, and using both blob locations helps to improve the accuracy of the subsequent chamfer-based alignment. Accordingly elimination could be, but preferably is not performed. Although the described implementation detects moving vehicle locations by using motion-compensated frame differences, those skilled in the art will appreciate that alternative methods for detecting vehicles in a scene that operate on either single or multiple image frames can also be used with the proposed algorithm [20-23].

To align a frame Iₜ₊₁ with the immediately temporally preceding frame Iₜ, the first algorithm may use an efficient alignment strategy. First, the algorithm may use the enhanced version of the FAST (Features from Accelerated Segment Test) [24] algorithm proposed in [25] to detect key-points in both images. The enhancement proposed in [25] allows FAST to have a good measure of cornerness, and to overcome its limitations for multi-scale features, while keeping its low computational complexity. Then the algorithm may extract the descriptors associated with the detected key-points using a FREAK (Fast Retina Keypoint) descriptor [26]. Unlike, SIFT or SURF, FREAK yields an efficiently computed binary descriptor which can be matched with much lower computational complexity using a simple Hamming distance measure. Finally, the algorithm may filter out the false matches and estimate the projective transformation that aligns the two frames using RANSAC.

The reader will appreciate that a frame Iₜ could instead be registered and aligned with an immediately temporally succeeding frame Iₜ₊₁. Also, since successive frames will have almost identical illumination and be captured with small differences in time and viewpoints, aligning successive frames together is an easy task that could instead be tackled using area or feature based image registration methods [27].

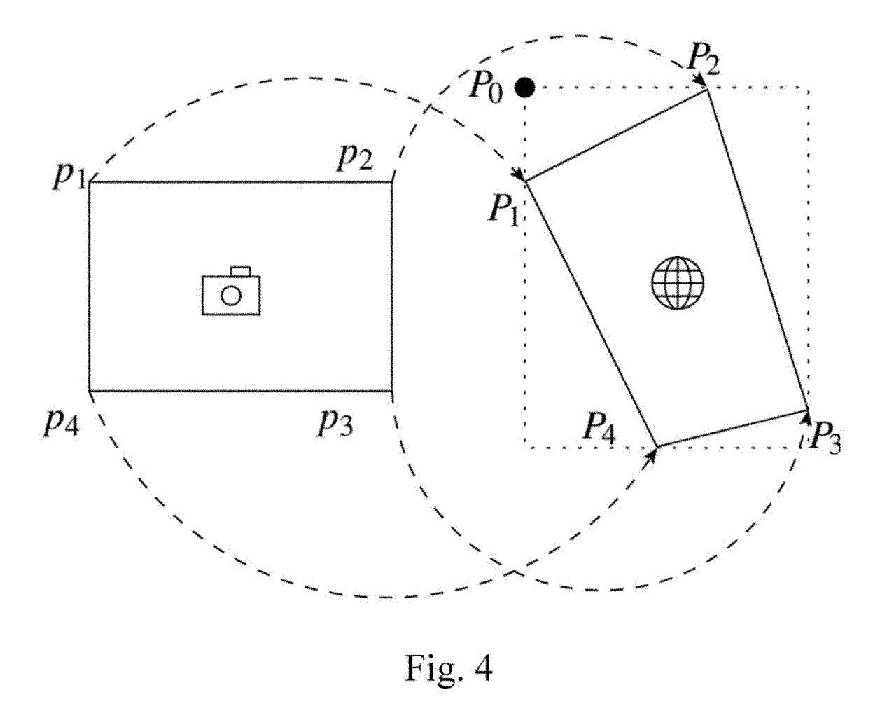

Generating a road network image coarsely aligned with Iₜ, hereafter labeled Iₜ^{r}, 200 involves extracting segments of the road network that lie within the field of view of the video frame Iₜ 210 and projecting the extracted segments into Iₜ^{r} using the coordinate system of Iₜ 220. Referring to FIG. 4, because the meta-data for the video frame provides the approximate geographic positions of the four corners of Iₜ, the algorithm can compute a projective transformation matrix H_{g} that transforms Iₜ from its coordinate system to a geo-referenced system as shown. The algorithm may estimate the parameters of H_{g} by solving the system of linear equations:

\tilde{P}ᵢ=s(Pᵢ−P₀)=H_{g}pᵢ, Equation (3)

where i∈{1, . . . , 4}, pᵢ are the coordinates of the i^{th} corner point in the Iₜ coordinate system, Pᵢ are the coordinates of the i^{th} corner point in a geo-referenced coordinate system, P₀ is a common reference point, and s is a reasonable scaling factor to relate the resolutions of the two coordinate systems. Both pᵢ and Pᵢ are represented in a homogeneous coordinate system, and the algorithm may use the direct linear transformation algorithm (DLT) [12] to compute H_{g}. Using the computed H_{g}, the algorithm may project segments of the vector road network back into the coordinate system of Iₜ. For a j^{th} road segment characterized by the geographical coordinates of both start and end points, road network pixel locations may be calculated by:

pⱼ=sH_{g}⁻¹(Pⱼ−P₀), Equation (4)

In other words, using Equation (4) the algorithm maps the geographical coordinate of the start and end points for each road segment into corresponding pixel locations in the original Iₜ video frame. The algorithm may then draw a line between those points in Iₜ^{r}. The algorithm could apply a line clipping algorithm [28] to clip any segment portions extending outside of the Iₜ image region in Iₜ^{r} 230. Thus the generation process creates a binary image Iₜ^{r} which contains the formerly vector-represented road network, alternately represented as rasterized series of line segments that are coarsely aligned with Iₜ.

Estimation of a final alignment between the aligned road network and vehicle detections 300 is performed using a chamfer distance metric. To align binary images Iₜ^{d} and Iₜ^{r} (obtained as described in the previous sections), one can define a distance ƒ(β) between them for an alignment specified by the projective transformation with parameter vector β.

Specifically (dropping the t subscript to simply notation), let pᵢ^{d} denote the coordinates of the non-zero pixels in I^{d}, i.e. pᵢ^{d}={x:I^{d}(x)≠0}, where i∈{1 . . . , N_{d}}, and N_{d} is the total number of non-zero pixels in I^{d} and, similarly, let pₖ^{r}={x:I^{r}(x)≠0} be the set of Nᵣ coordinates for which I^{r} is nonzero, where both pᵢ^{d} and pₖ^{r} are represented in homogeneous coordinates. The chamfer distance ƒ(β) is then:

$$f ( β ) = \frac{1}{{N}_{d}} {\sum }_{i = 1}^{{N}_{d}} {min}_{k} d ( {p}_{k}^{r} , {H}_{β} {p}_{i}^{d} ) \qquad Equation ( 5 )$$

where the transformation H_{β} is as defined in Equation (1a) and d(a,b)≡∥a−b∥₂². The nonzero locations in I^{r} correspond to positions located on the road network. Under the assumption that most of the nonzero locations in I^{d} correspond to moving vehicle detection locations, the chamfer distance is essentially the sum of the minimum squared-distances between moving vehicle detection locations and corresponding nearest points in the road network. Computationally, ƒ(β) represents the chamfer distance between I^{d} and I^{r} under the projective alignment specified by the parameter vector β, which can be computed efficiently using the distance transform [29]. To align the vehicle detection locations I^{d} with the road network I^{r}, the algorithm seeks the optimal projective transformation parameter vector β* that minimizes the chamfer distance ƒ(β).

To compute the optimal parameters, the first algorithm may use the Levenberg-Marquardt (LM) non-linear least squares optimization algorithm [30] to minimize Equation (5) in an iterative fashion. In each iteration, the LM algorithm estimates a parameter update vector δ∈ [symbol] ^{8×1} such that the value of the objective function is reduced when moving from β to β+δ, with the parameters converging to a minimum of the objective function with the progression of iterations. The parameter update vector δ is obtained by solving the following system of equations:

(A|λI)δ=−b(β), Equation (6)

where b∈ [symbol] ^{8×1} is the residual vector computed as

$$b = \frac{\partial f}{\partial β} = - \frac{2}{{N}_{d}} {\sum }_{i = 1}^{{N}_{d}} {J}_{i}^{T} [ {min}_{k} ( {p}_{k}^{r} - {H}_{β} {p}_{i}^{d} ) ] , \qquad Equation ( 7 )$$

and Jᵢ∈ [symbol] ^{2×8} is the Jacobian matrix computed at each transformed point H_{β}pᵢ^{d}, computed as

$${J}_{i} = \frac{\partial {H}_{β} {p}_{i}^{d}}{\partial β} = [ \frac{\partial {H}_{β} {p}_{i}^{d}}{\partial {h}_{1}} , … , \frac{\partial {H}_{β} {p}_{i}^{d}}{\partial {h}_{8}} ] , \qquad Equation ( 8 )$$

and A∈ [symbol] ^{8×8} is the approximation to the Hessian matrix, computed as

$$\begin{matrix}A = {\sum }_{i = 1}^{{N}_{d}} {J}_{i}^{T} {J}_{i} , where & Equation ( 9 ) \\ \frac{\partial {H}_{β} {p}_{i}^{d}}{\partial {h}_{1}} = {[ \frac{{x}_{i}^{d}}{w} , 0 ]}^{T} , \frac{\partial {H}_{β} {p}_{i}^{d}}{\partial {h}_{2}} = {[ \frac{{y}_{i}^{d}}{w} , 0 ]}^{T} , \\ \frac{\partial {H}_{β} {p}_{i}^{d}}{\partial {h}_{3}} = {[ \frac{1}{w} , 0 ]}^{T} , \frac{\partial {H}_{β} {p}_{i}^{d}}{\partial {h}_{4}} = {[ 0 , \frac{{x}_{i}^{d}}{w} ]}^{T} , \\ \frac{\partial {H}_{β} {p}_{i}^{d}}{\partial {h}_{5}} = {[ 0 , \frac{{y}_{i}^{d}}{w} ]}^{T} , \frac{\partial {H}_{β} {p}_{i}^{d}}{\partial {h}_{6}} = {[ 0 , \frac{1}{w} ]}^{T} , \\ \frac{\partial {H}_{β} {p}_{i}^{d}}{\partial {h}_{7}} = {[ - \frac{{x}_{i}^{d} z}{{w}^{2}} , - \frac{{x}_{i}^{d} z}{{w}^{2}} ]}^{T} , \\ \frac{\partial {H}_{β} {p}_{i}^{d}}{\partial {h}_{8}} = {[ - \frac{{y}_{i}^{d} z}{{w}^{2}} , - \frac{{y}_{i}^{d} z}{{w}^{2}} ]}^{T} , and \\ w = {x}_{i}^{d} {h}_{7} + {y}_{i}^{d} {h}_{8} + 1 , z = {x}_{i}^{d} {h}_{1} + {y}_{i}^{d} {h}_{2} + {h}_{3} . & Equation ( 10 )\end{matrix}$$

At each iteration, the parameter vector β is updated to the value β+δ, and the process is continued until convergence.

### First Registration Algorithm Example and Results

We evaluated the first algorithm using a WAMI dataset recorded using a CorvusEye 1500 Wide-Area Airborne System [3] for the Rochester, N.Y. region. For the vector road map data, we used OpenStreetMap (OSM) [31]. OpenStreetMap is a collaborative project which uses free data sources such as Volunteered Geographic Information (VGI) [32] to create a freely editable map of the world. The map data from OSM is available in a vector format where each road in a road network for a given area is represented by multiple road segments connecting start and end points specified in the map data by their latitude and longitude coordinates. Other properties of each road such as its type (highway, residential, etc.) and its number of lanes, etc. are included in the data. The WAMI video frames were each 4400×6600 pixels, and stored using NITF 2.1 format [33], which stores a JPEG 2000-encoded image and meta-data within a single file. The files were parsed to extract the four approximate geographical coordinates for the corners associated with each video frame.

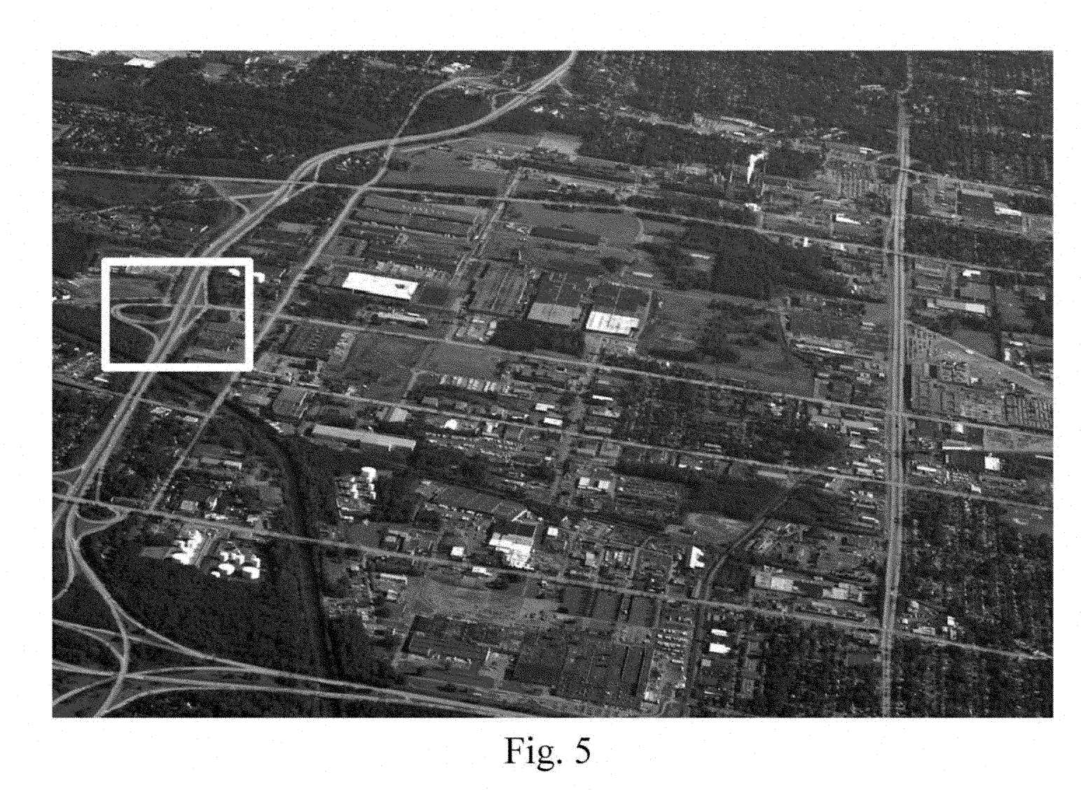

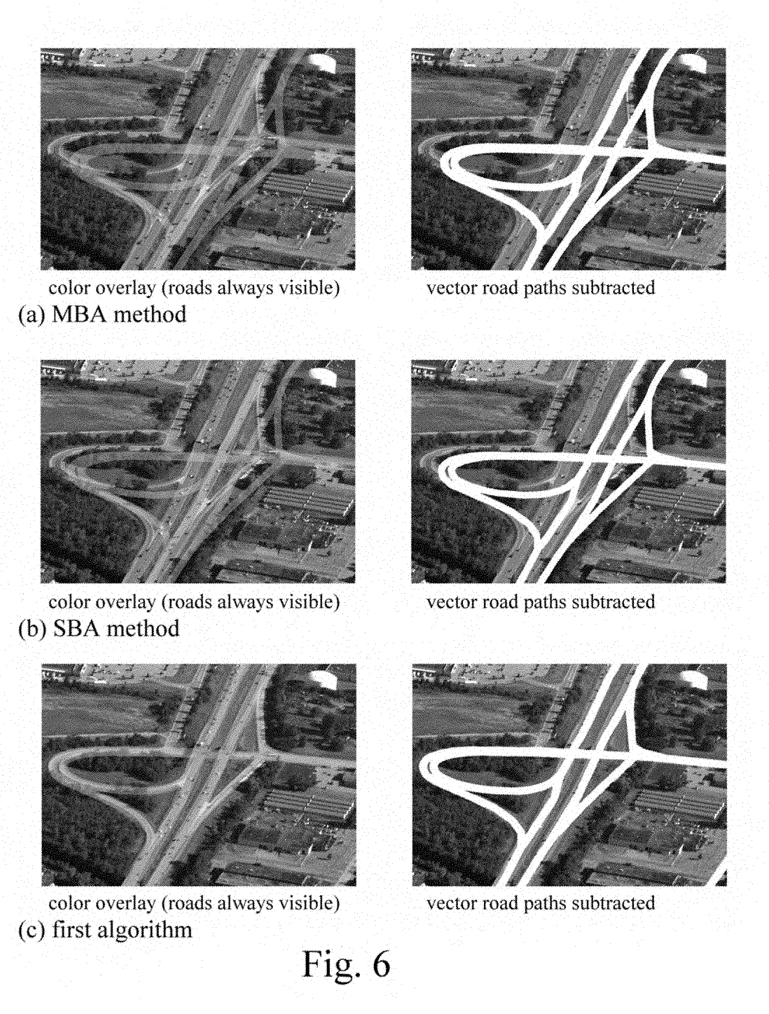

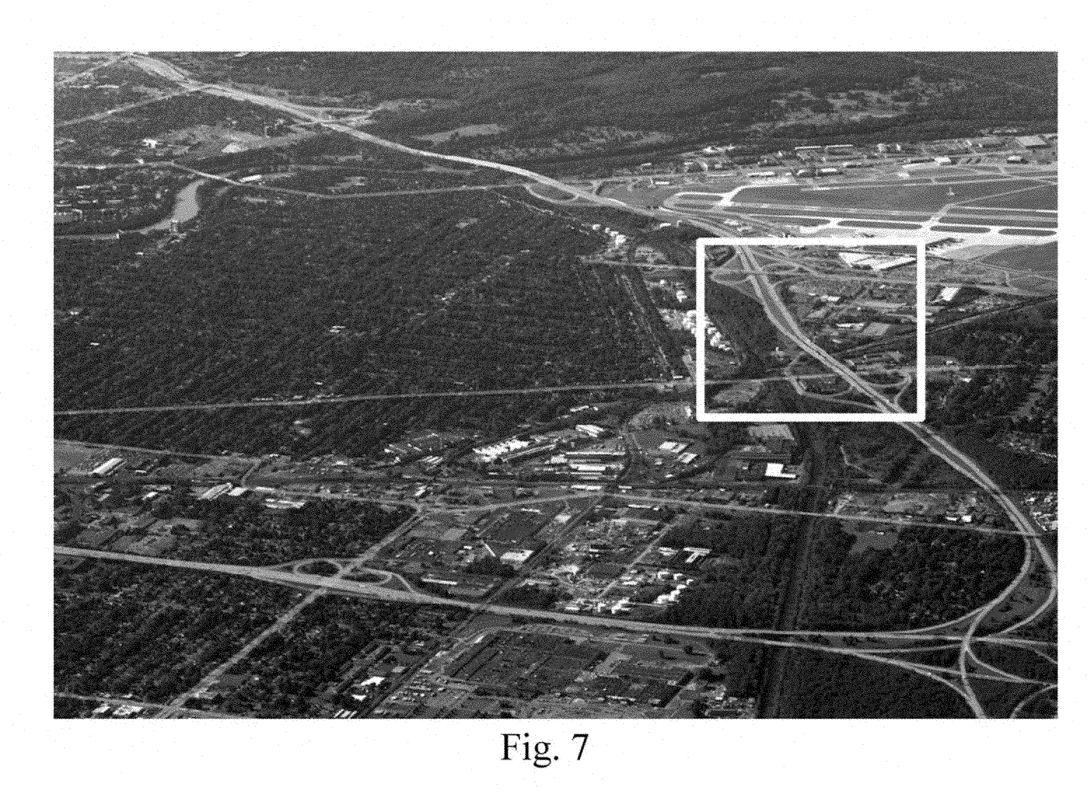

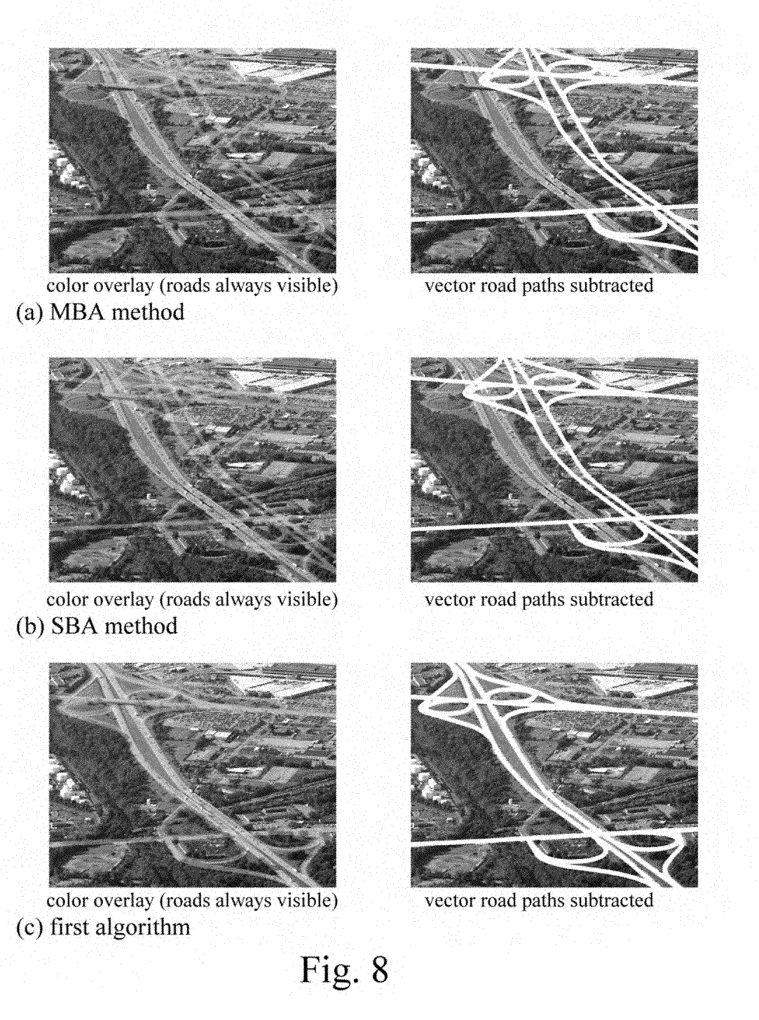

We compared the first algorithm with two alternative methods which we will refer to as “Meta-data Based Alignment (MBA)” and “SIFT matching with auxiliary geo-referenced image (SBA).” The MBA method simply uses the video frame meta-data to get the aligned road network. The SBA method tries to match SIFT features between the video frame and an auxiliary geo-referenced image (in this case, taken from Google Maps), with the meta-data being used to ortho-rectify the video frame, and correspondences between the ortho-rectified image and the geo-referenced image being obtained through SIFT feature matching. Specifically, we extracted SIFT features from the ortho-rectified image and the geo-referenced image, then, for each feature point in one image, searched for the corresponding point in the other image within a circle with radius r, where center of the circle was determined by the approximate alignment parameters from the meta-data and the radius of the search was set by determining the maximum spatial error for the approximate alignment provided by the meta-data. After obtaining these putative correspondences, we used RANSAC to filter out the incorrect matches and to estimate the final transformation between the geo-referenced image and the ortho-rectified image. We applied this transformation to the vector road network, then reversed the ortho-rectification to get the final result. Visual comparisons of intersections, captured within representative WAMI video frames shown in FIGS. 5 and 7, which were aligned using the SBA method, the MBA method, the first algorithm, and a manually performed “ground truth” alignment are shown in FIGS. 6 and 8, respectively. From the images included in FIGS. 6 and 8, we can see that the first algorithm offers a significant enhancement over the MBA and SBA methods. The MBA method has significant errors because of the inaccuracy of the meta-data parameters due to the limited accuracy of on-board navigation devices. The SBA method does not improve significantly upon the MBA method because of spurious correspondences found by the SIFT matching between the video image and the auxiliary, geo-referenced (Google Maps) image, which have significant differences due to severe view point change, different illumination conditions, and different image capture dates. The first algorithm does not face the challenges associated with aligning images captured under different conditions because it aligns image-derived moving vehicle detections to the road network by transforming both into a binary representation that then allows efficient computation of the chamfer distance as a meaningful metric.

To provide a quantitative comparison, manually generated “ground truth” road networks for four exemplary video frames were compared to final alignments generated using the MBA method, the SBA method, and the first algorithm using three metrics to quantify the accuracy of alignment. First, the chamfer distance between the ground truth road network and each of the other post-alignment road networks was calculated. For each point in the estimated road network, the distance to the closest point in the ground truth network was computed and the average of these closest distances over all the points was computed. The results are shown in Table 1, with lower numbers representing a lower sum of minimum distance error (note: for this evaluation distances in pixel units were used instead of squared distances, although the overall trends are similar for both metrics). The results in Table 1 reinforce the results observable in FIGS. 6 and 8. The first algorithm has a much lower value for the chamfer distance, highlighting the fact that the first algorithm offers a significant improvement over both the MBA and SBA methods.

TABLE 1
Chamfer distance between the ground truth
road network and generated road network

| | MBA | SBA | 1st Algorithm |
|---|---|---|---|
| Video | chamfer | chamfer | chamfer |
| Frame no. | distance | distance | distance |
| 1 | 28.22 | 17.1 | 6.36 |
| 300 | 122.28 | 83.09 | 9.30 |
| 416 | 36.95 | 26.49 | 8.69 |
| 820 | 87.35 | 87.29 | 6.68 |

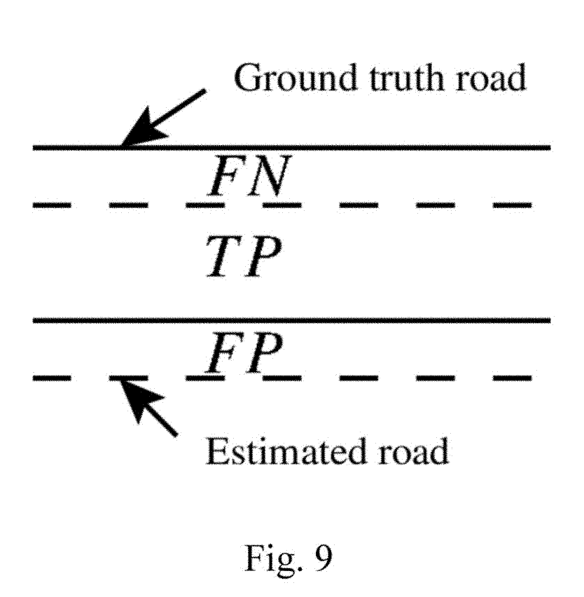

Second, a precision-recall performance metric was calculated. The lines in the TT image representing the road network were collectively dilated by a dilation amount to approximate the “ground truth” road widths, and then a precision calculated for a range of dilation amounts. A similar process was applied to the road networks generated by the MBA and SBA methods. Specifically, for each dilated width, the pixel locations corresponding to the true positives (TP), the false positives (FP), and false negatives (FN) were determined as illustrated in FIG. 9. After specifying TP,FP, and FN, calculating precision and recall is straightforward using:

$$Precision = \frac{Tp}{TP + FP} and Recall = \frac{TP}{TP + FN}$$

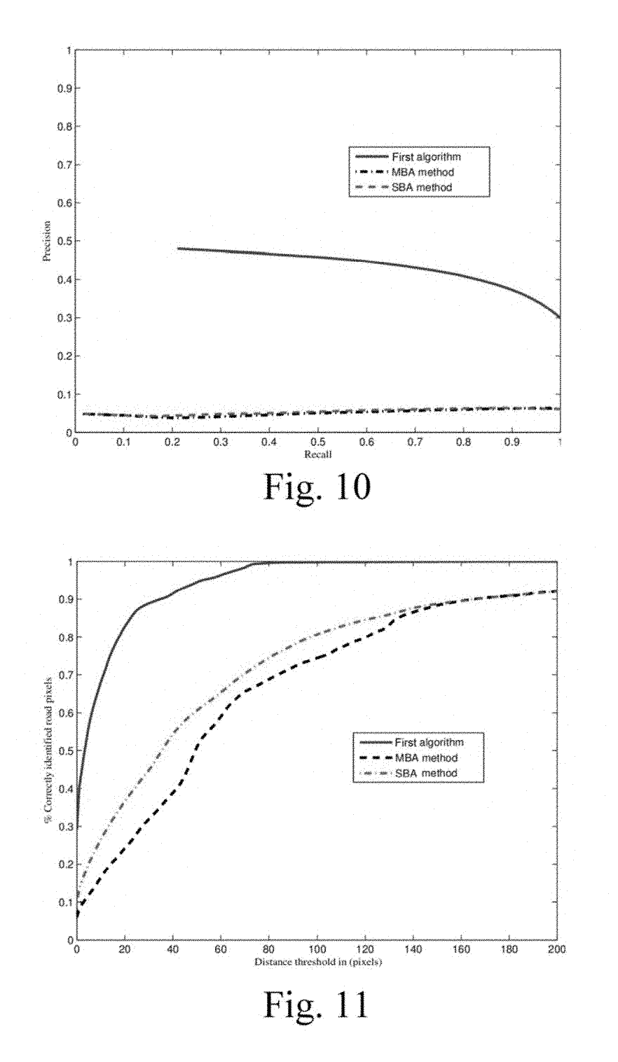

A precision-recall plot contrasting the metric for the MBA method, SBA method, and the first algorithm for video frame no. 820 is shown in FIG. 10. Once again, the significant improvement offered by the first algorithm is apparent from the plot.

Third, a relative positional accuracy metric was calculated. A process similar to that used for the second, precision-recall metric was followed, except that the relative positional accuracy metric examines the percentage of accurately estimated road pixels for which the estimated road pixel location is within some threshold distance of a ground truth road pixel location. The illustrated percentages were averaged over the four video frames listed in Table 1 and plotted against the permissible threshold distance in FIG. 11. Yet again, the significant improvement offered by the first algorithm is apparent from the plot.

A working implementation of the first algorithm, implemented in C++ using OpenCV [34], takes 5 to 10 seconds to align the vector road network with a WAMI video frame. The expensive part of the working implementation is its use of LM minimization, which can be further sped-up through the use of GPU-based co-processing or a GPU-based implementation, and particularly by parallelizing the Jacobian calculations (which are computed independently for each pixel). Such parallelization, while beyond the scope of the disclosure, may permit near-real-time processing at WAMI-like frame rates, allowing the algorithm to be incorporated into WAMI platforms for real-time applications.

### First Registration Algorithm Conclusions

The first algorithm accurately co-registers vector road map data with aerial imagery, such as WAMI video frames, by exploiting vehicular motion. Specifically, local motion observed in WAMI video frames, after compensation for global motion via standard techniques, has been found to correspond strongly to vehicle movement, so that, by minimizing the chamfer distance between vehicle locations identified through movement (inter-frame local motion) and a binary image of the road network described in the vector map data, the algorithm provides an effective method for aligning the two. The algorithm does not require direct feature matching between these otherwise very different data modalities and also eliminates the need for an auxiliary geo-referenced image as an intermediary. Results obtained for test datasets demonstrate the effectiveness of the algorithm. Both visually and in terms of numerical metrics for alignment accuracy, the algorithm offers a very significant improvement over available alternatives.

Second Registration Algorithm with Improved Vehicle Detection

A similar second algorithm can also exploit a latent synergy between the problems of co-registration and moving vehicle detection: an improved alignment of vector road map data to aerial imagery can improve the detection of on-road vehicles by allowing off-road artifacts to be filtered out and, vice versa, an improved detection of on-road vehicles versus off-road artifacts (including off-road vehicles) in aerial imagery can improve registration of the aerial imagery to vector road map data by using only “true” moving vehicle detection locations to align the aerial imagery with the road network. This replaces the previous assumption that most of the nonzero locations in I^{d} correspond to moving vehicle detection locations.

The second algorithm estimates an optimal alignment by minimizing a joint probabilistic objective function that combines (a) the classification of moving vehicle detections as true on-road vehicles vs. other detections and (b) a penalty for misalignment between putative on-road detection locations and the vector road map under a parametric transformation. The algorithm iterates within an Expectation Maximization (EM) framework that alternates between expectation (E) and maximization (M) steps. In the (E) step, we estimate the posterior probabilities that individual moving vehicle detections are “true.” These estimated posterior probabilities are used to define the complete data likelihood that's maximized in the (M) step in order to find the optimal alignment parameters which are equivalently obtained by minimize the weighted chamfer distance between the vehicle detections and the road network, where the weights are the estimated posterior probabilities that the individual moving vehicle detections are “true.” Efficient computation of the latter metric is accomplished using the distance transform [18]. The second algorithm again has the advantage that by posing registration as a problem of aligning moving vehicle detection locations with the vector road network, we implicitly transfer both the aerial imagery and the geo-referenced vector road map data to representations that can be easily matched. But the second algorithm also has the advantage of accommodating inevitable “false” detections that do not correspond to on-road vehicles, and thus provides significant robustness to the quality of the detections used in calculating a final estimated alignment. The principal assumption of the second algorithm, again, is that the scene contains a forked road network, and the practical use of the second algorithm similarly does not depend on the aerial camera sensor type.

In contrast to the first algorithm, the second algorithm uses a probabilistic version of the chamfer distance (as defined above). The weight applied to the chamfer distance for each moving vehicle detection corresponds to the probability that the respective detection is “true,” i.e., a detection at a location on the road network as opposed to an artifact located or movement occurring off the road network. The probabilities are subsequently updated based upon the proximity of each vehicle detection to the intermediately aligned road network, and fed into the maximization step of the EM framework. By introducing these probabilistic weights to the second algorithm, the effect of spurious vehicle detections on the final estimated road network alignment is greatly reduced.

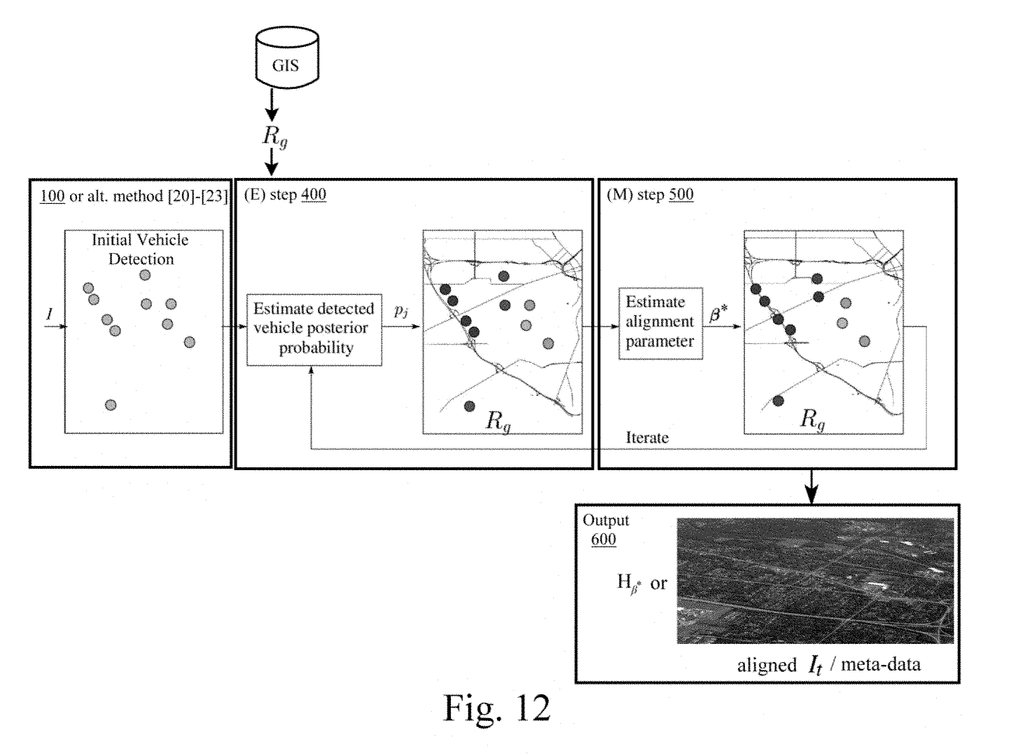

A high level overview of the second algorithm is shown in block-diagram format in FIG. 12, along with illustrative drawings. The second algorithm, like the first, may perform a frame-to-frame registration 100 and compute a displaced frame-to-frame difference [19] between video frames 130 for initial vehicle detection, or alternately use one of the other aforementioned methods. However, the second algorithm subsequently applies an Expectation Maximization (EM) framework by, first, estimating the posterior probabilities that individual vehicle detections are true, on-road vehicle detections 400 and, second, estimating an intermediate alignment between the road network and “true” moving vehicle detections by minimizing the weighted chamfer distance between them 500. When the likelihood function p(d|θ), which quantifies the probability of the observed data under the estimated pameters for reliability of vehicle detection and the alignment, sufficently converges upon a maximal value, the last intermediate estimated alignment is deemed a final estimated alignment between the aerial imagery and the road network 600. The algorithm provides the optimal parameters for an estimated coordinate transformation that aligns the aerial imagery to the road network. Again, this coordinate transformation can be applied to the aerial imagery to align it with the vector road map data or vice versa. This estimated final alignment may be output to control a computer system, such as a traffic analysis system or vehicle tracking system, and enable the system to more accurately geo-reference aerial imagery, or may generate and output an aligned dataset containing video frames and meta-data (such as geographical coordinates for the corners associated with the video frame) derived from the final estimated alignment. This enables additional information from rich sources of GIS information to be exploited in further applications of the imagery.

Estimating the posterior probabilities that individual moving vehicle detections are true 400 involves a detection-by-detection evaluation of detection locations versus locations within the road network. Formally, for a WAMI video frame I, there will be Nᵥ putative vehicle detections. The location of each detection is represented in the WAMI video frame coordinate system as (xⱼ, yⱼ), and the vector road map R_{g} is defined within a 2D Cartesian coordinate system (χ, ζ), derived from a geographical coordinate system such as latitude and longitude, as set of roads with the k^{th} road r^{k} being represented as a sequence of spatial locations (^{r}χᵢ^{k}, ^{r}ζᵢ^{k}) along the road. Ultimately, the coordinate systems will be interrelated by the transformation parameter vector β of the geometric transformation [symbol] _{β}:(x, y)→(χ, ζ), i.e., the variable determining the intermediate and, eventually, final estimated alignment between the aerial imagery and the vector road map data. For each detection, the minimum distance dⱼ of its mapped location to the road network R_{g} is:

$${d}_{j} ( β ) = {min}_{i , k} D ( {(}^{r} {χ}_{i}^{k} , {}_{}^{r}{ζ}{}_{i}^{k} ) , {τ}_{β} \{ {x}_{j} , {y}_{j} \} ) , \qquad Equation ( 11 )$$

where (^{r}χᵢ^{k}, ^{r}ζᵢ^{k}) are the i^{th} point's spatial location on the k^{th} road r^{k} in R_{g}, and D(a, b)≡∥a−b∥₂² is the squared Euclidean distance from the detection location to the closest point on the road network. Due to the inherent noise in the moving vehicle detection process, e.g., step 130, the detections are classified as belonging to either a true detection class or a false detection class. The true detection class represents on-road moving vehicle detections, and the false detection class represents both off-road moving vehicle detections and off-road non-vehicle (artifact) detections. For that purpose, the second algorithm associates with each detection a latent variable zⱼ∈{0,1} that indicates whether the detection corresponds to the true detection class (zⱼ=1) or the false detection class (zⱼ=0). The distribution of the latent variable may be modeled as a Bernoulli distribution parameterized by unknown parameter γ, i.e., p(zⱼ=1)=γ. The detections that belong to the true class are more likely to be located near a road in the road network, and less likely to be faraway, so that the distribution of their associated distance dⱼ may be modeled as an exponential distribution with parameter λ, i.e., dⱼ˜Exp(λ). Otherwise, the detections that belong to the false class can be located equally at any location in the video frame I, so that the distribution of their associated distance dⱼ may be modeled as a uniform distribution u(0,M²) as in [35-37], where M is size of the video frame I. The criterion for iteration within the EM framework is maximization of a likelihood function:

p(d|θ) Equation (12)

where θ={β, λ, γ}, and d=[(d₁, . . . , d_{N}_{ᵥ}]T∈ [symbol] ^{N}^{ᵥ}^{×1} is a vector containing all distances dⱼ. Assuming that the vehicle detections are independent given the parameters θ, then

$$\begin{matrix}p ( d \vert θ ) = {\prod }_{j = 1}^{{N}_{v}} p ( {d}_{j} \vert θ ) , where & Equation ( 12 a ) \\ \begin{matrix}p ( {d}_{j} \vert θ ) = {\sum }_{{z}_{j} ∈ \{ 0 , 1 \}} p ( {d}_{j} , {z}_{j} \vert θ ) \\ = p ( {z}_{j} = 1 ) p ( {d}_{j} \vert θ , {z}_{j} = 1 ) + \\ p ( {z}_{j} = 0 ) p ( {d}_{j} \vert θ , {z}_{j} = 0 ) \\ = γ λ {e}^{- λ {d}_{j}} + \frac{( 1 - γ )}{{M}^{2}} .\end{matrix} & Equation ( 12 b )\end{matrix}$$

Iteration within an Expectation Maximization (EM) framework [38] thus provides an elegant way to find the maximum likelihood solution in the presence of these latent variables.

The posterior distribution of the latent variables zⱼ is evaluated using a current estimate for the parameters θ^{t} in order to find the expectation of the complete-data log likelihood, which is later maximized in the (M) step 500 to compute a new estimate of the parameters θ^{t+1}. Following the notation used in [38], the expectation of the complete-data log likelihood is defined as:

$$𝒬 ( θ , {θ}^{t} ) = {\sum }_{j = 1}^{{N}_{v}} p ( {z}_{j} = 1 \vert {d}_{j} , {θ}^{t} ) ln [ γ λ {e}^{- λ {d}_{j}} ] + p ( {z}_{j} = 0 \vert , {d}_{j} , {θ}^{t} ) ln [ \frac{( 1 - γ )}{{M}^{2}} ] , \qquad Equation ( 13 )$$

which, by dropping the constant terms, becomes:

$$𝒬 ( θ , {θ}^{t} ) = {\sum }_{j = 1}^{{N}_{v}} {p}_{j} ( ln [ γ ] + ln [ λ ] - λ {d}_{j} ) + ( 1 - {p}_{j} ) ln [ 1 - γ ] , \qquad Equation ( 13 a )$$

where pⱼ=P(zⱼ=1|dⱼ, θ^{t}) is the posterior probability distribution of the latent variables zⱼ, and can be estimated using Bayes rule as:

$$\begin{matrix}{p}_{j} = \frac{p ( {d}_{j} \vert {z}_{j} = 1 , {θ}^{t} ) p ( {z}_{j} = 1 \vert {θ}^{t} )}{p ( {d}_{j} \vert {θ}^{t} )} \\ = \frac{γλ {e}^{- λ {d}_{j}}}{γλ {e}^{- λ {d}_{j}} + \frac{( 1 - γ )}{{M}^{2}}} .\end{matrix} \qquad Equation ( 13 b )$$

Equation (13b) thus provides posterior probabilities that the moving vehicle detections are true, on-road vehicle detections. As indicated earlier, those posterior probabilities are subsequently used to estimate an intermediate alignment between the video frame I and the road network R_{g}.

Estimating an intermediate alignment between the road network and individual vehicle detection locations classified as “true” 500 involves using the estimated pⱼ to obtain a new estimate of the parameters by maximizing Equation (12a), i.e.:

$${θ}^{L + 1} = arg {max}_{θ} 𝒬 ( θ , {θ}^{t} ) . \qquad Equation ( 14 )$$

By taking the derivative of Equation (12a) with respect to each parameter and setting it to zero, the optimal parameters in θ^{L|⊥} are:

$$\begin{matrix}{γ}^{*} = \frac{{\sum }_{j = 1}^{{N}_{υ}} {p}_{j}}{{N}_{υ}} , & Equation ( 15 ) \\ and & \\ {λ}^{*} = \frac{{\sum }_{j = 1}^{{N}_{υ}} {p}_{j}}{{\sum }_{j = 1}^{{N}_{υ}} {p}_{j} {d}_{j}} . & Equation ( 16 )\end{matrix}$$

γ* represents an improved estimate of the fraction of detections expected to fall within the true class, i.e., the γ parameter of Bernoulli distribution discussed above, and λ* represents how close detections are expected to be to the road network R_{g} in order to fall within the true class, i.e., the λ parameter of the exponential distribution discussed above. The improved estimates are fed back into the EM framework during a subsequent iteration and subsequent performance of step 400.

The optimal parameter β* that maximizes Equation (12a) may be equivalently estimated by minimizing the objective function:

$$f ( β ) = {\sum }_{j = 1}^{{N}_{υ}} {p}_{j} {d}_{j} ( β ) . \qquad Equation ( 17 )$$

with respect to β. This means that the optimal transformation parameter vector β* should map the locations of vehicle detections within the true class to be in a close proximity with the road network, as estimated by the weighted chamfer distance.

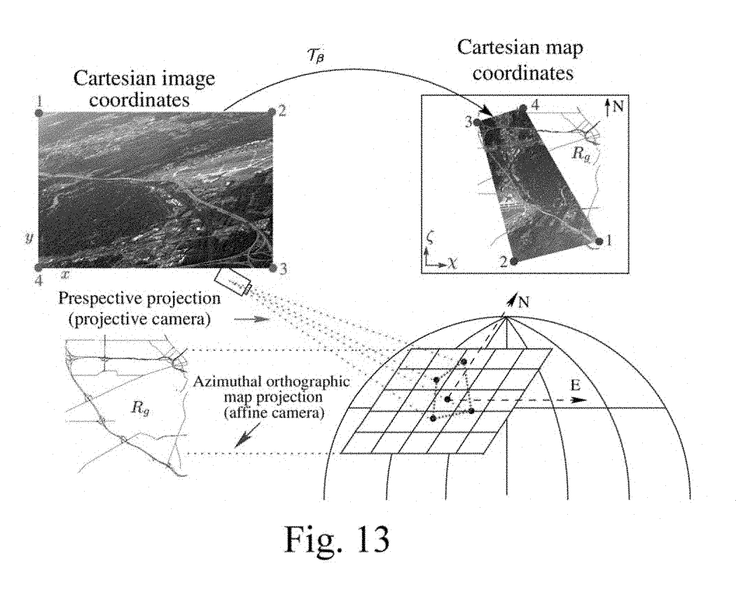

The vector road map R_{g} initially provides the locations of road segments in the geographical coordinate system (longitude and latitude), which is a spherical coordinate system. An azimuthal orthographic map projection [39] may be used to transform the road network from the geographical coordinate system to the 2D Cartesian map coordinate system (χ, ζ). The azimuthal orthographic map projection projects the geographical coordinates of locations on a reference surface representation of the Earth to a plane that is tangent to the reference surface at the map's central point. To limit the distortion associated with this projection, the map's central point should be at the approximate center of the captured scene. The azimuthal orthographic map projection may be viewed as a mapping from a 3D scene to a 2D imaging plane as if it was captured using a virtual affine camera which has its camera center located at infinity, and its image plane is the tangent plane shown in the bottom right of FIG. 13. The same scene may be projected to the 2D Cartesian image coordinates (x, y) using the projective camera that is used to capture the scene. Assuming a generally planar scene, the (χ, ζ) and (x, y) coordinate systems are related through a single homography [11]. Thus, the objective function of Equation (17) can be re-written as:

$$f ( β ) = {\sum }_{j = 1}^{{N}_{υ}} {p}_{j} {min}_{i , k} D ( {p}_{i , k}^{r} , {H}_{β} {p}_{j}^{υ} ) , \qquad Equation ( 17 a )$$

where no is a homography characterized by the parameter β=[β₁, . . . , β₈]^{T}, and pⱼ^{v}=[xⱼ, yⱼ, 1]^{T}, p_{i,k}^{r}=^{r}χᵢ^{k}, ^{r}ᵢ^{k}, 1₋^{-T}. are the homogeneous coordinates of the j^{th} vehicle in the video frame I and its closest location of the nearest road in R_{g} respectively. To align the moving vehicle detection locations with the road network R_{g}, the second algorithm may seek the optimal homography parameter vector β* that minimizes the objective function ƒ(β) of Equation (17a). For that minimization, the algorithm may use the Levenberg-Marquardt (LM) [30] non-linear least squares optimization algorithm which minimizes Equation (17a) in an iterative fashion. In each iteration, the LM algorithm estimates the parameter update vector δ∈ [symbol] ^{8×1} such that the value of the objective function is reduced when moving from β to β+δ, with the parameters converging to a minimum of the objective function with the progression of iterations.

Because the objective functions of Equations (5) and (17a) differ, the following abbreviated description of the calculation of the parameter update vector δ is included. The derivatives of Jacobian and Hessian matrices are obtained, with appropriate adjustments, as otherwise described above.

(A+ηI)δ=b(β), Equation (18)

where b∈ [symbol] ^{8×1} is the residual vector which computed as

$$b = \frac{\partial f}{\partial β} = - 2 {\sum }_{j = 1}^{{N}_{υ}} {p}_{j} ( {min}_{i , k} ( {p}_{i , k}^{r} - {H}_{β} {p}_{j}^{υ} ) ) {J}_{j}^{T} , \qquad Equation ( 19 )$$

and Jⱼ∈ [symbol] ^{2×8} is the Jacobian matrix computed at each transformed point H_{β}pⱼ^{v}, which is computed as

$${J}_{j} = \frac{\partial {H}_{β} {p}_{j}^{υ}}{\partial β} = [ \frac{\partial {H}_{β} {p}_{j}^{υ}}{\partial {β}_{1}} , … , \frac{\partial {H}_{β} {p}_{j}^{υ}}{\partial {β}_{8}} ] , \qquad Equation ( 20 )$$

and A∈ [symbol] ^{8×8} is the approximation of the Hessian matrix, obtained as Equation (21)

$$A = {\sum }_{j = 1}^{{N}_{υ}} {J}_{j}^{T} {J}_{j} ,$$

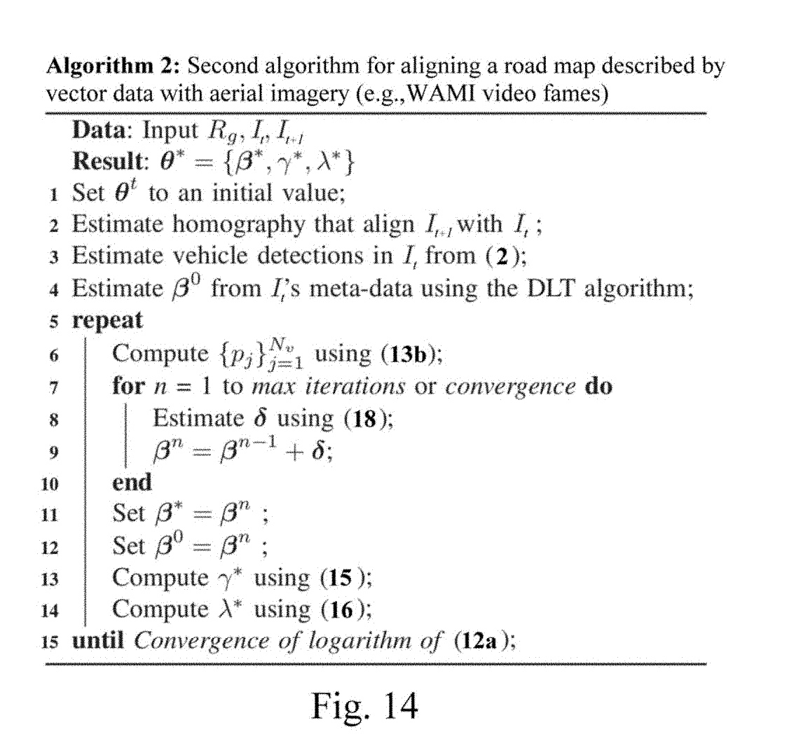

At each iteration n, the homography parameter vector is updated as βⁿ−βⁿ⁻¹+δ, and this process is continued until convergence. It is important for the LM, as an iterative optimization algorithm, to start from a good initial solution estimate. Given the approximate geographical coordinates of the four corners of the WAMI video frame obtainable from the meta-data, the second algorithm can calculate the associated locations in the (χ, ζ) coordinate system from the azimuthal orthographic map projection. From the correspondences of the locations of those non-collinear corner points in both the (x, y), and the (χ, ζ) coordinates, the second algorithm can use a direct linear transformation (DLT) [12] to estimate the initial solution β⁰. The second algorithm is shown in abbreviated form in FIG. 14.

### Second Registration Algorithm Example and Results

We evaluated the second algorithm using three WAMI datasets that contained both visible range (V) and infra-red range (IR) imagery. The first is the CORVUS(V) visible range dataset, which was recorded using the CorvusEye 1500 Wide-Area Airborne System [3] for the Rochester, N.Y. region. The second is the CORVUS(IR) mid-wave infra-red range dataset recorded with the same system for the Lakeland, Fla. region. The third is the Wright-Patterson Air Force Base (WPAFB) 2009 visible range data set [40], which recorded over the WPAFB, OH region. The WAMI frames provided by the three datasets were stored using NITF 2.1 format [33]. For the vector road map, we used OpenStreetMap (OSM) [31]. In our experiments, we set λ=1e−5, γ=0.5, and τ=0.15. We compared our second algorithm with the MBA method, the SBA method, and the first algorithm.

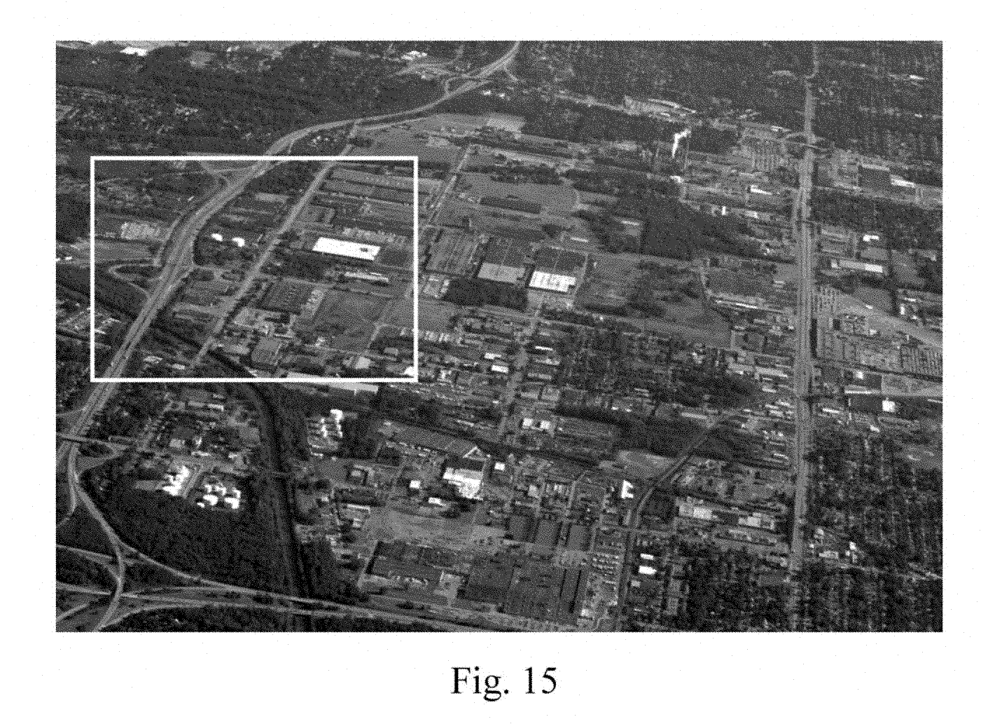

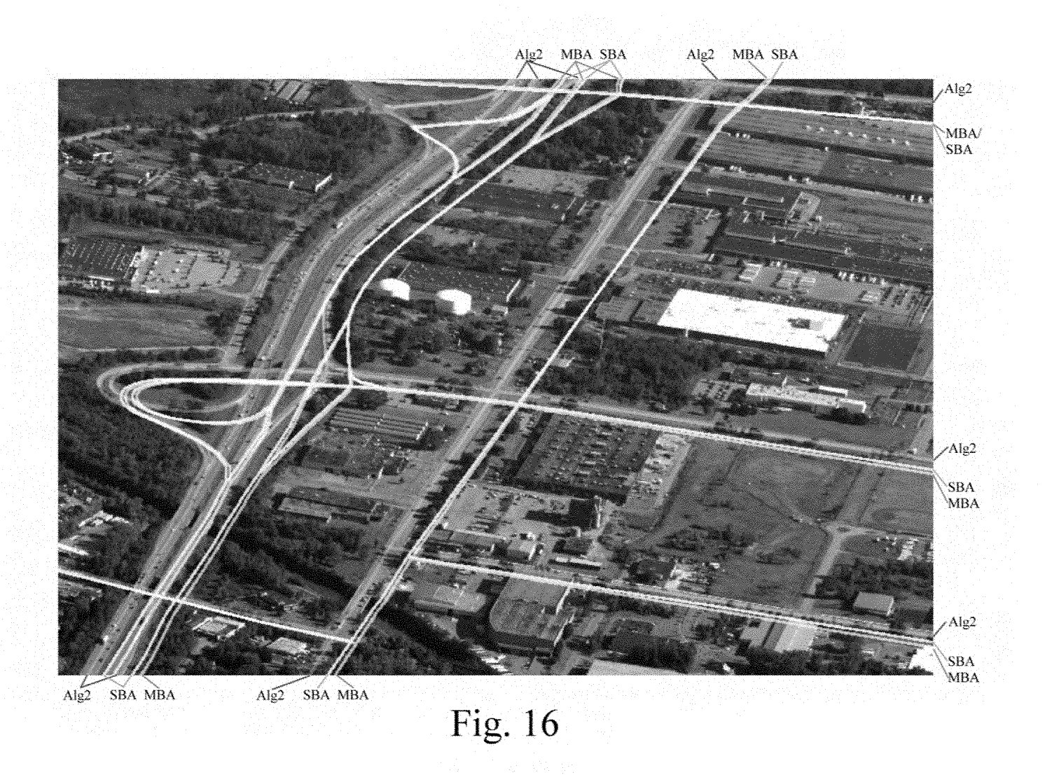

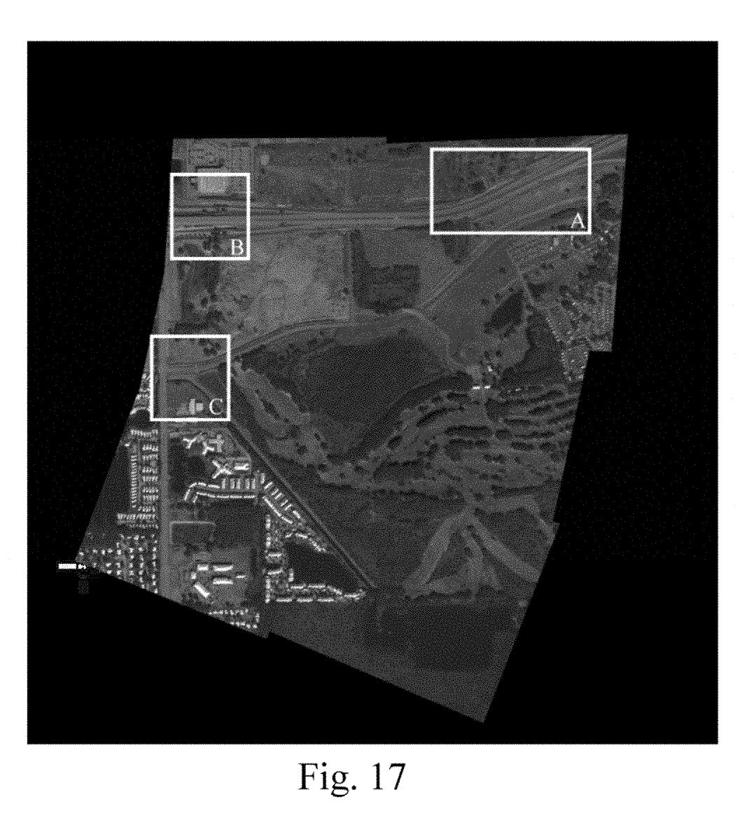

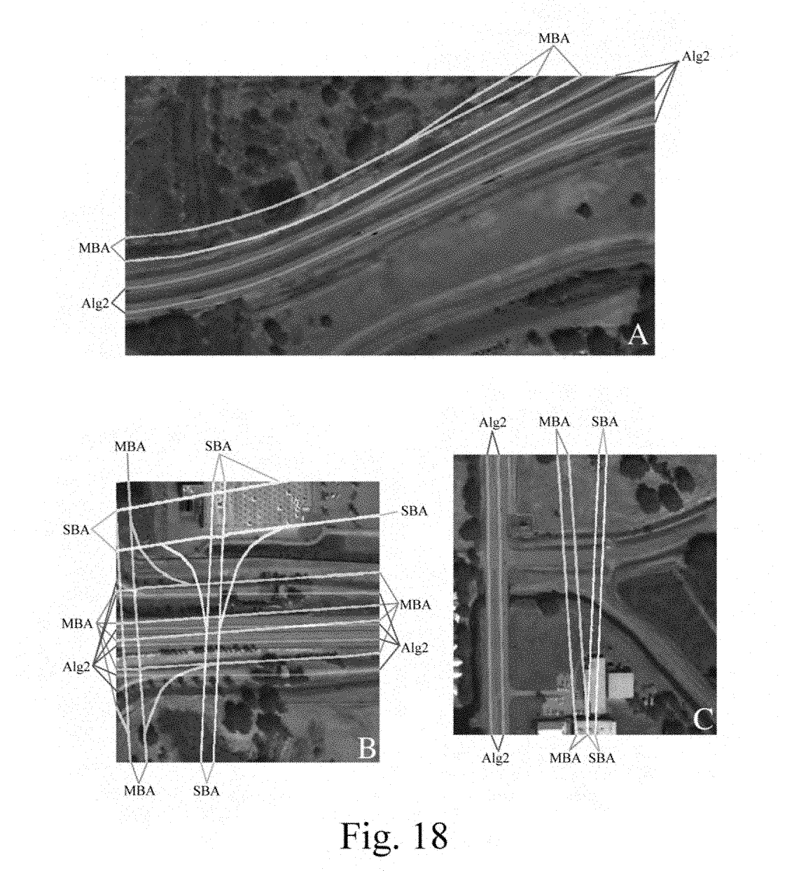

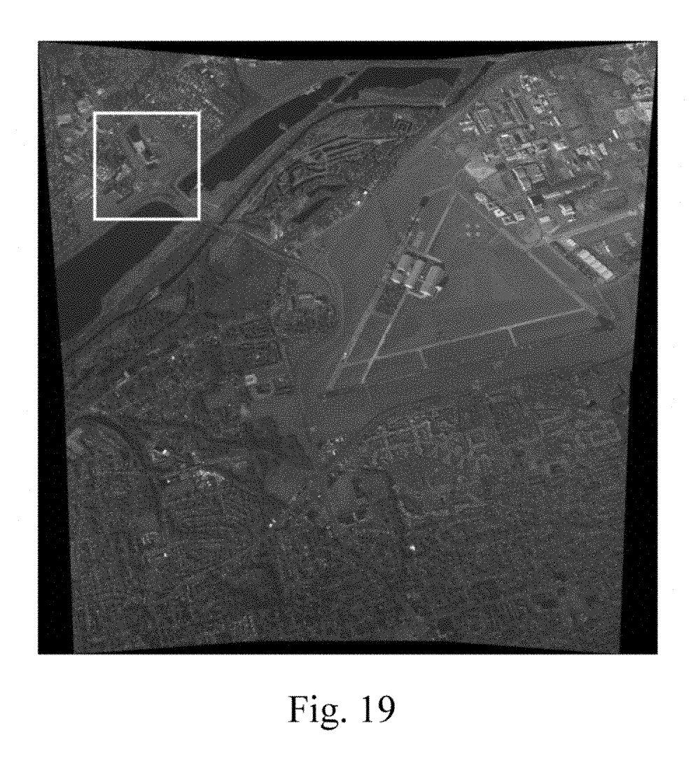

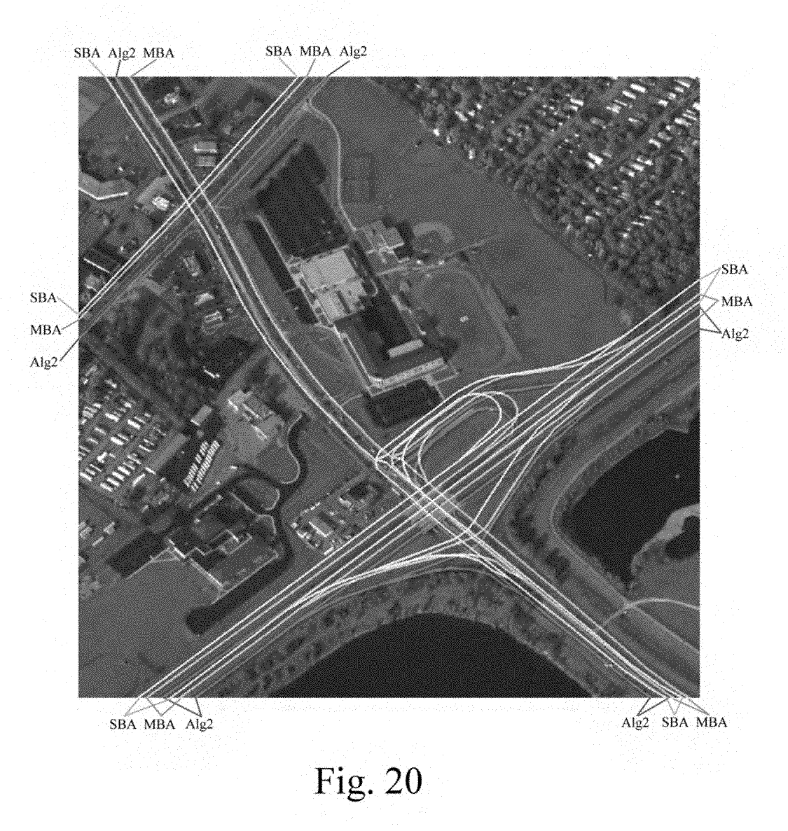

Visual comparisons of intersections, captured within representative WAMI video frames shown in FIGS. 15, 17, and 19, which were aligned using the SBA method, the MBA method, and the second algorithm in FIGS. 16, 18, and 20, respectively. From the images, we can see that the proposed method offers a significant enhancement over MBA which depends only on the meta-data to get an aligned road network and over SBA which uses SIFT and auxiliary geo-referenced Google map image. The errors contained the MBA and SIFT method results were explained previously, but it is also important to note that the SBA method produces more inaccurate results when applied to infra-red imagery because the difference in spectrum between the infra-red video frames and the auxiliary geo-referenced (Google Maps) images substantially impairs matching between feature points in the images, and creates a poor estimated alignment. Neither of the disclosed algorithms face the challenges associated with aligning images captured under such different conditions because both align vehicle detections to the road network by minimizing the distances between them, and thus provide a great alignment accuracy without need to match static image features.

To provide a quantitative comparison, manually generated “ground truth” road networks for a few test areas in each dataset were compared to final alignments generated using the MBA method, the SBA method, and both algorithms using the chamfer distance, precision-recall, and relative positional accuracy metrics discussed above. Table 2 shows the chamfer distance between the ground truth road network and the aligned road network. Table 2 highlights three important results. First, it reinforces the results observable in FIGS. 16, 18, and 20. The second algorithm has a much lower value for the chamfer distance, highlighting the fact that the second algorithm offers a further improvement over the alternate methods for both visual range and infra-red range imagery. Second, although both the first and second algorithms rely on moving vehicle detections to obtain the aligned road network, the second algorithm provides better accuracy than the first, as it takes into consideration the reliability of the detector and weights each detection appropriately before minimizing the distance between the on-road moving vehicle detections and the road network. Third, the SBA method provides little enhancement over the MBA method for visual range imagery, and performs much worse than the MBA method in the case of infra-red imagery, which indicates the challenges associated with using SIFT feature matching when dealing with different imaging conditions.

TABLE 2
Chamfer distance between the ground truth
road network and generated road network

| | | MBA | SBA | 1st Algorithm | 2nd Algorithm |
|---|---|---|---|---|---|
| | Test | chamfer | chamfer | chamfer | chamfer |
| Dataset | area | distance | distance | distance | distance |
| CORVUS | Area 1 | 28.22 | 17.1 | 6.36 | 3.95 |
| (V) | Area 2 | 122.28 | 83.09 | 9.30 | 2.07 |
| | Area 3 | 36.95 | 26.49 | 8.69 | 3.45 |
| | Area 4 | 87.35 | 87.29 | 6.68 | 5.21 |
| CORVUS | Area 5 | 450.19 | 462.76 | 3.15 | 2.13 |
| (IR) | Area 6 | 104.28 | 387.84 | 4.25 | 2.14 |
| | Area 7 | 179.13 | 266.85 | 5.12 | 3.11 |
| | Area 8 | 81.38 | 116.37 | 17.94 | 11.34 |
| WPAFB | Area 9 | 14.19 | 11.87 | 9.04 | 3.15 |
| | Area 10 | 16.03 | 14.23 | 6.15 | 4.12 |
| | Area 11 | 13.09 | 10.84 | 8.28 | 3.36 |
| | Area 12 | 13.90 | 10.18 | 8.86 | 4.43 |

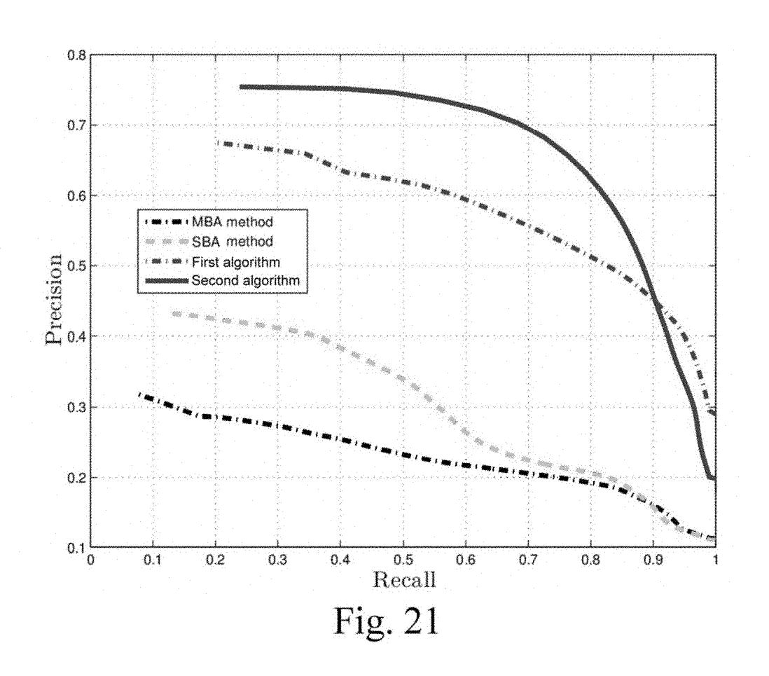

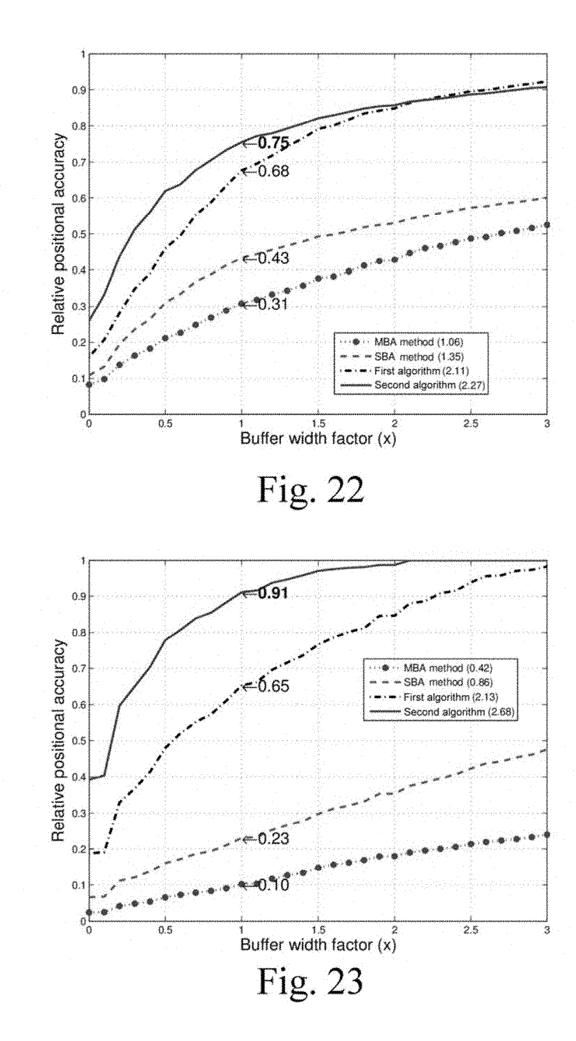

FIG. 21 plots precision-recall for test area 1. As in the first algorithm, the improvement offered by the second algorithm over the other methods is readily apparent. FIGS. 22 and 23 plot relative positional accuracy, i.e., the measure of how much of the aligned road network is within a buffer distance of the center of the ground truth roads of the network, for test areas 1 and 2, respectively. The second algorithm provides the largest area under the curve (AUC) compared to the other methods, which highlights the improvement of the road alignment accuracy of the second algorithm in comparison to both the first algorithm and other methods.

Third Registration Algorithm with Improved Vehicle Tracking

A third algorithm exploits a similar synergy between the problems of co-registration and vehicle tracking: an improved alignment of vector road map data to aerial imagery can improve the tracking of individual on-road vehicles through a progression of aerial images by favoring vehicle trajectories which align with the location and directionality of the road network, while improved vehicle tracking in aerial imagery can improve registration of the aerial imagery to vector road map data by using reliably determined vehicle trajectories to align the imagery with the road network, again using both location and directionality information. This likewise replaces the assumption in the first algorithm that most of the nonzero locations in I^{d} correspond to moving vehicle detection locations, and adds additional accuracy for the alignment by exploiting the directionality information in both vehicle trajectories and in the roads of the road network. The synergy can be realized by solving a joint optimization problem, e.g., by using an iterative alternating optimization algorithm to obtain estimates of vehicle trajectories and estimates of aerial imagery registration parameters.

Specifically, the third algorithm estimates, via an alternating optimization, vehicular trajectories over a multi-frame temporal window (typically 10-15 frames) and the best geometric transformation for aligning those trajectories with the road network. The algorithm may be implemented using a maximum a posteriori probability (MAP) formulation that penalizes trajectory deviations from the road network using a chamfer distance metric, appropriately modified [41] for the problem setting to incorporate directionality, as well as a successive approach to identifying and extending reliable trajectories for individual vehicles based on detections in individual frames and the alignment of the oriented trajectories with the road network directionality.

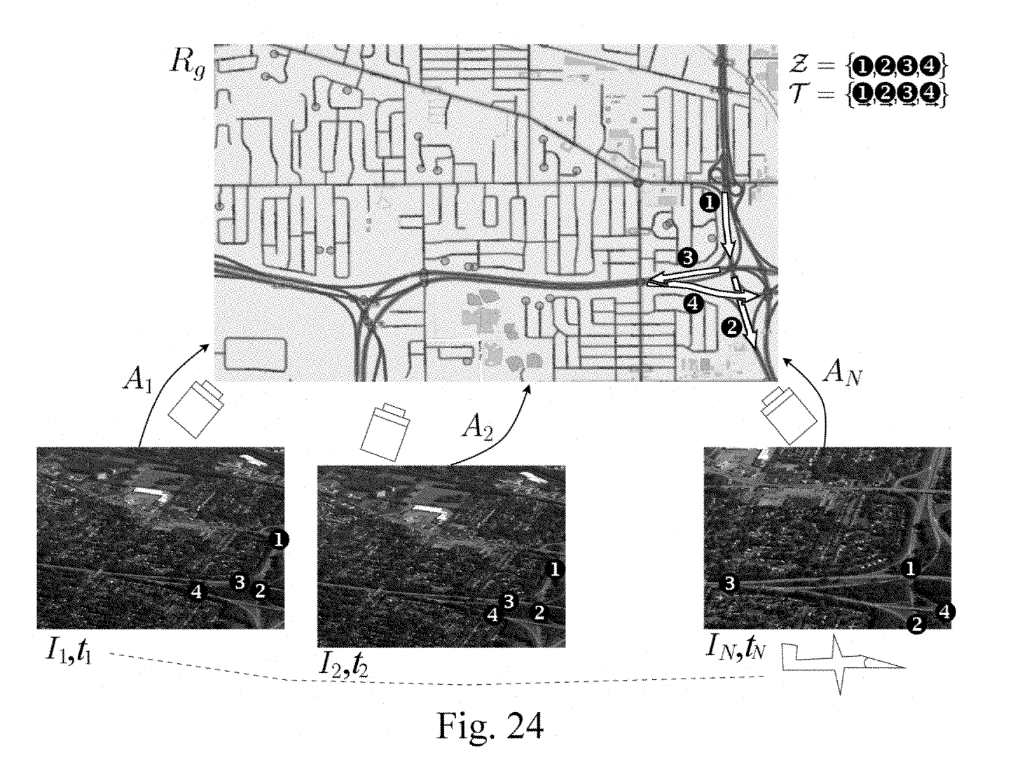

FIG. 24 provides a simplified illustration of the setting for the formal optimization problem presented below. Given a vector road map R_{g} defined in an orthographic projection [39] using corresponding 2D orthogonal geo-referenced coordinates (χ, ζ)(e.g., coordinates derived from latitude and longitude), the road network may be treated as a set where the k^{th} road r^{k} is represented as a sequence of spatial locations (^{r}χᵢ^{k}, ^{r}ζᵢ^{k}) along the road. Imagery [symbol] =(I₁(x¹, y¹), I₂(x², y²), . . . , I_{N}(x^{N}, y^{N})) consists of a series of N video frames I, taken over a set of N time instants t₁<t₂< . . . <t_{N}, where (xⁱ, yⁱ) are the pixel locations along the native orthogonal coordinates of the image sensor when capturing the i^{th} video frame. Under the assumption that the captured scene is planar, a 3×3 homography matrix Aᵢ relates the image coordinates (xⁱ, yⁱ) for the i^{th} video frame to the orthographic geo-referenced 2D coordinates (χ, ƒ) via the homogeneous transformation relation [χ, ζ, s]^{T}=Aᵢ_{_{−}}⁻x, y, 1]^{T}, where s is a scaling factor [42]. For each of L moving vehicles captured in the video frames one defines a trajectory, where for the l^{th} vehicle the trajectory is a sequence of N spatial locations Tₗ=(v₁^{l}, v₂^{l}, . . . v_{N}^{l}) at the time instants t₁, t₂, . . . , t_{N}, respectively (in the geo-referenced coordinate system of R_{g}), and where vᵢ^{l} [symbol] (^{v}χᵢ^{l}, ^{v}ζᵢ^{l})^{T} is the location of the l^{th} vehicle at time tᵢ corresponding to the i^{th} frame. The problem is to estimate the transformations [symbol] ={Aᵢ}ᵢ₋₁ that register the captured video frames to the geo-referenced map R_{g} and to track the moving vehicles captured in the video frames by estimating the vehicle trajectories T={Tₗ}. In a maximum a posteriori probability (MAP) formulation for estimation (with R_{g} being given, and thus not called out to simplify notation), the optimal estimates of the registration and the trajectories are:

$$\{ \hat{𝒯} , \hat{A} \} = arg {max}_{𝒯 , A} P ( 𝒯 , A \vert ℐ ) . \qquad Equation ( 22 )$$

A joint formulation of the problem benefits both the trajectory and alignment estimation sub-problems. For the trajectory estimation sub-problem, vehicle locations captured in each individual frame coordinate system may be mapped into a common reference coordinate system R_{g} and then trajectories estimated within the common coordinate system of R_{g}, allowing the third algorithm to leverage the rich geo-spatial information provided by the vector road map data in R_{g} to improve the accuracy of the estimated trajectories. For example, road direction may be applied to the otherwise ambiguous process of assigning an R_{g}-mapped vehicle location to a given trajectory, as detailed below. For the alignment estimation sub-problem, estimating an accurate registration between the coordinate systems for WAMI video frames and R_{g} is challenging, as discussed earlier. However, because both the estimated trajectories and R_{g} will have the same vector representation, aligning them becomes substantially easier and more accurate than alignments using only WAMI video frame meta-data. Thus, the trajectory and alignment estimation sub-problems complement each other, and solving them jointly produces more accurate and robust solutions than solving the two sub-problems independently.

Instead of solving Equation (22) directly, one may split the imagery into a series of temporal windows and solve the problem within each temporal window, propagating the estimates between the windows. Each temporal window should be short enough that substantive spatial overlap is maintained between the video frames within each temporal window and across adjacent temporal windows. This allows a significant computational simplification for the alignment and trajectory estimation sub-problems. For the alignment estimation sub-problem, by exploiting image feature overlap across the temporal window to initially co-register the frames within that window, one can cut down the number of transformations to be estimated from [symbol] ={Aᵢ}ᵢ₋₁^{N} to one, A₁, since all frames are co-registered. For the trajectory estimation sub-problem, this provides some computational improvement because the number of vehicle detections to be simultaneously considered will be limited to the number occurring within the temporal window. Performing the alignment and tracking operations over a temporal window instead of over the entire duration of the WAMI capture will only slightly degrade solution accuracy since most of the relevant information for inter-frame registration and tracking comes from a relatively short, immediate-time neighborhood. To simply notation in the ensuing description, the previously mentioned sequence of N frames will be assumed to lie within the single temporal window that is the focus of the rest of the description.

The geometry of the captured scene will remain similar over adjacent WAMI video frames so that conventional feature based matching methods, such as SIFT [4] and SURF [10], may successfully find corresponding locations for use in robust homography estimation methods such as RANSAC [11]. Therefore over the temporal window the transformations [symbol] ={Aᵢ}ᵢ₋₁^{N} can equivalently be represented by the transformation A₁ and a set of homography matrices

$${\{ {H}_{i}^{i + 1} \}}_{i - 1}^{N - 1}$$

that relate successive video frames, where Hᵢ^{j} transforms the image coordinates (x^{j}, y^{j}) for the j^{th} frame to the image coordinates (xⁱ, yⁱ) for the i^{th} frame. Also, by using co-registered frames within the temporal window, a background model is readily obtained for the entire window (for example, by using a median filter), which in turn allows ready detection of moving vehicle locations. Specifically, in the i^{th} video frame detected vehicle locations may be represented as a sequence zₖⁱ=(^{v}xₖⁱ, yₖⁱ), k=1, 2, . . . of points in the frame's native pixel coordinates. Then a tracking-by-detection framework may operate on the vehicle locations detected in each WAMI frame (using a vehicle detector). One may approximate the estimation in Equation (22) by

$$\{ \hat{𝒯} , {\hat{A}}_{1} \} = arg {max}_{𝒯 , {A}_{1}} P ( 𝒯 , {A}_{1} \vert ) , \qquad Equation ( 22 a )$$

where [symbol] ={zₖⁱ}_{i,k} is the complete setof vehicular detections. This approximation becomes exact under the assumption that the inter-frame registrations are a function of the image data and that the complete set of vehicular detections [symbol] constitutes sufficient statistics [42]. By applying Bayes' rule, Equation (22a) becomes

$$\{ \hat{𝒯} , {\hat{A}}_{1} \} = arg {max}_{𝒯 , {A}_{1}} P ( \vert 𝒯 , {A}_{1} ) P ( 𝒯 , {A}_{1} ) , \qquad Equation ( 22 b )$$

where P( [symbol] , A₁) is the prior joint distribution, and P( [symbol] | [symbol] , A₁) is the likelihood distribution.

Equation (22b) may be evaluated by introducing a set of latent variables and treating the equation as an incomplete likelihood [43] that is the marginal of a complete likelihood involving the latent variables that can be readily evaluated via an explicit expression. By defining a latent variable w_{k,l}ⁱ that associates the k^{th} vehicle detection in the i^{th} frame (zₖⁱ) with the l^{th} trajectory, specifically, w_{k,l}ⁱ is 1 if the detection [symbol] ₖⁱ is the l^{th} vehicle's location in the i^{th} frame and 0 otherwise:

$${ω}_{k , l}^{i} = \{ \begin{matrix}1 & if {A}_{1} {H}_{1}^{i} {z}_{k}^{i} = {υ}_{i}^{1} \\ 0 & otherwise\end{matrix} \qquad Equation ( 23 )$$

where H₁ⁱ=Hᵢ₋₁ⁱ . . . H₁². The full 3D set of latent variables can be organized as a set of 2D arrays, one per video frame: for the i^{th} frame, the 2D array Ωⁱ=[w_{k,l}ⁱ] indexes the vehicle detections in the frame by k and the trajectories by l and has an entry of 1 in a given position only if the trajectory and the detection are associated. A vehicle corresponding to a trajectory may or may not be detected in a given frame and a detection in a frame may or may not associate with a given trajectory. Thus there is a set [symbol] of feasible associations that satisfy the constraints:

$$\begin{matrix}{\sum }_{k} {ω}_{k , l}^{i} {=}^{def} {η}_{l}^{i} = \{ \begin{matrix}1 & if {l}^{th} vehicle is detected in frame i \\ 0 & otherwise\end{matrix} \\ {\sum }_{l} {ω}_{k , l}^{i} {=}^{def} {κ}_{k}^{i} = \{ \begin{matrix}1 & \begin{matrix}if {k}^{th} detection in frame i \\ corresponds to a vehicle ' s trajectory \end{matrix} \\ 0 & otherwise\end{matrix}\end{matrix}$$

For a complete set of latent variables Ω=(Ω¹, Ω², . . . Ω^{N})=(w_{k,l}^{u})_{i,k,l} the complete likelihood is:

$$P ( , Ω \vert 𝒯 , {A}_{1} ) = {α}_{1} {\prod }_{i , k , l} ( δ ( {z}_{k}^{i} - {( {A}_{1} {H}_{1}^{i} )}^{- 1} {υ}_{i}^{l} ) [ ( 1 - γ ) {ω}_{k , l}^{i} + γ ( 1 - {ω}_{k , l}^{i} ) ] + βδ ( {ω}_{k , l}^{i} ) ( 1 - {\sum }_{j = 1}^{L} δ ( {z}_{k}^{i} - {( {A}_{1} {H}_{1}^{i} )}^{- 1} {υ}_{i}^{j} ) ) ) \qquad Equation ( 24 )$$

where α₁ is a normalizing constant determined to ensure a total probability sum of 1, β is probability that a pixel not corresponding to an on-road vehicular-trajectory location is detected as a vehicle “spuriously”, δ(•) denotes the Kronecker delta function, and γ is the fraction of trajectory locations that are missed in the detection process. This model assumes that a subset of the total detections are spurious, i.e., do not correspond to on-road vehicular trajectories and the remaining fraction are non-spurious, i.e., correspond to on-road vehicular trajectories. The model in Equation (24) assumes that spurious detections are uniformly distributed over pixels in the video frame that do not align with the given trajectory locations for the vehicles under the specified alignment and non-spurious detections do not have any location error. However, the third algorithm could be generalized to account for location errors in the detector by formulating the above distribution as a continuous distribution that also includes uncertainty in the location of non-spurious detections.

The likelihood distribution P( [symbol] | [symbol] , A₁) in Equation (22b) is obtained by marginalizing the complete likelihood P( [symbol] ,Ω| [symbol] , A₁) in Equation (24) over all possible sets of association variables Ω, i.e.

$$P ( \vert 𝒯 , {A}_{1} ) = {\sum }_{Ω ∈ 𝒲} P ( , Ω \vert 𝒯 , {A}_{1} ) \qquad Equation ( 25 )$$

The trajectories [symbol] (in the geo-referenced coordinate system of R_{g}) do not depend on the transformation A₁, and therefore the prior distribution factors as

P(z [symbol] ,A₁)=P(A₁)P( [symbol] ) Equation (26a)

where

P( [symbol] )=Pₘₒₜᵢₒₙ( [symbol] )P_{road}( [symbol] ) Equation (26b)

is the prior distribution of [symbol] and is composed of two terms. The first is Pₘₒₜᵢₒₙ( [symbol] ) which measures the global motion trend consistency of the trajectories in [symbol] , and the second term is P_{road}( [symbol] ) which measures how well trajectories are matched with roads in R_{g}. For the first, since the temporal window size should be small relative to variations in traffic dynamics, one may assume that the speeds of the individual vehicles are nearly constant over the duration covered by the N frame temporal window. To enforce this constant speed constraint, one may define the spatial velocity vₗ^{l}^{ᵢ} for the l^{th} vehicle at time instance tᵢ as vₗ^{l}^{ᵢ}=[^{v}χᵢ^{l}−^{v}χᵢ₋₁^{l}, ^{v}ζᵢ^{l}−^{v}ζᵢ₋₁^{l}]^{T}. Then, the variation of the l^{th} vehicle velocity over the temporal time window may be modeled as:

$${C}_{l}^{υ} - {\sum }_{i - 2}^{N} {‖ {v}_{l}^{{t}_{i + 1}} - {v}_{l}^{{l}_{i}} ‖}^{2} . \qquad Equation ( 27 )$$

and, by assuming that trajectories are independent from each other, Pₘₒₜᵢₒₙ( [symbol] ) becomes

$$\begin{matrix}{P}_{motion} ( 𝒯 ) = {\prod }_{{T}_{l} ∈ 𝒯} {P}_{motion} ( {T}_{l} ) , & Equation ( 28 a ) \\ {P}_{motion} ( {T}_{l} ) = {α}_{2} e ( - {c}_{l}^{υ} ) , & Equation ( 28 b )\end{matrix}$$

where α₂ is the normalizing constant required to ensure a unit probability sum over all [symbol] ₗ in [symbol] . Variations in velocity contribute to increased value of Cₗ^{v} for the corresponding trajectory. Therefore, the above formulation penalizes the variations of velocity via the contribution of velocity differences over the temporal time window. For the second, P_{road}( [symbol] ), since the tracked objects are vehicles which normally move on roads, one may assume that reliable trajectories will align with those roads. Accordingly, P_{road} may penalize deviations of trajectories from the road network. Specifically, assuming independence trajectories, P_{road}( [symbol] ) becomes

$$\begin{matrix}{P}_{road} ( 𝒯 ) = {\prod }_{{T}_{l} ∈ 𝒯} {P}_{road} ( {T}_{l} ) , & Equation ( 29 a ) \\ {P}_{road} ( {T}_{l} ) = {α}_{3} e ( - {c}_{l}^{d} ) , & Equation ( 29 b )\end{matrix}$$

where α₃ is the normalizing constant required to ensure a unit probability sum over all Tₗ in [symbol] , and Cₗ^{d} is the deviation from trajectory [symbol] ₗ to the roads in the road network R_{g}. The deviation Cₗ^{d} is mathematically defined to incorporate components corresponding to the distance between individual vehicle positions and orientations along its trajectory with the road network. A directional chamfer distance [41] may describe Cₗ^{d} mathematically:

$${C}_{l}^{d} = \frac{1}{N} {\sum }_{i = 1}^{N} {min}_{j , k} d ( {υ}_{i}^{l} , {(}^{r} {𝒳}_{j}^{k} {,}^{r} {Ϛ}_{j}^{k} ) ) + λ {\vert}^{υ} {θ}_{i}^{l} {-}^{r} {θ}_{j}^{k} \vert \qquad Equation ( 30 )$$

where ^{r}θⱼ^{k} is the orientation of the k^{th} road at the point (^{r}χⱼ^{k}, ^{r}ζⱼ^{k}), and ^{v}θᵢ^{l} is the orientation of the l^{th} vehicle at location vᵢ^{l}, and λ is the weight for orientation mismatch. This formulation of P_{road} penalizes disagreement between each trajectory and the available road network information, because the calculated directional chamfer distance Cₗ^{d} jointly penalizes both positions and orientation differences between a trajectory and the nearest road point within the road network R_{g}.

For A₁, one may assume that the prior distribution is approximately uniform over the neighborhood of its initialization, as determined by the WAMI meta-data, for example, and negligible outside of that neighborhood. The role of the term P(A₁) in Equation (25) is therefore limited to setting a reasonable initialization, and need not be used further.

With these definitions and simplifications, and by noting that maximizing P( [symbol] ,A₁| [symbol] ) is equivalent to maximizing log(P( [symbol] ,A₁| [symbol] )), the optimal joint trajectories and alignment may be obtained by maximizing:

$$E ( 𝒯 , {A}_{1} ) = log {\sum }_{Ω ∈ 𝒲} P ( , Ω \vert 𝒯 , {A}_{1} ) - {\sum }_{{T}_{l} ∈ 𝒯} ( {C}_{l}^{υ} + {C}_{l}^{d} ) \qquad Equation ( 31 )$$

with respect to both [symbol] and A₁. It can be very challenging to estimate a [symbol] and A₁ that maximize Equation (31) due to the huge number of the possibilities of the association variable Ω. Therefore we assume that the probability mass accumulates strongly over the maximizing association (including equivalent allocations due to the degeneracy introduced by the process of assigning indices) so that the problem becomes a maximization of:

$$\begin{matrix}E ( 𝒯 , {A}_{1} , Ω ) = log P ( , Ω \vert 𝒯 , {A}_{1} ) - {\sum }_{{T}_{l} ∈ 𝒯} ( {C}_{l}^{υ} + {C}_{l}^{d} ) & Equation ( 32 a ) \\ ( ) with respect to 𝒯 , {A}_{1} , and Ω , i . e . \text{:} & \\ \{ \hat{𝒯} , {\hat{A}}_{1} , \hat{Ω} \} = arg {max}_{𝒯 , {A}_{1} , Ω} E ( 𝒯 , {A}_{1} , Ω ) & Equation ( 32 b )\end{matrix}$$

where the “hat” over the parameter indicates the estimate of the parameter.

Accordingly, the goal of the third algorithm is to estimate the transformation Â₁ that maps vehicular detections form the WAMI video frames' native coordinate system to the road network R_{g} coordinate system, and to estimate the trajectories [symbol] from the given vehicle detections [symbol] , such that both Â₁ and [symbol] maximize Equation (32a). However, these vehicular detections [symbol] cannot be assumed to be complete because some vehicles may not detected in one or many WAMI video frames. Given potentially incomplete vehicular detections [symbol] , one should note that knowing Ω and A₁ combined is equivalent to knowing the trajectories except for any points corresponding to missing detections, and thus the algorithm focuses on estimating trajectories by linking vehicle detections together over the N WAMI video frames. Complete trajectories can be inferred in video frames where a trajectory's location is missed in detection in a post processing, because the likelihood provides no information in the case of a missed detection and therefore the trajectory is inferred entirely based on the prior detection (essentially using interpolation). From the point of view of maximizing Equation (32), a good solution is a one that estimates:
(a) Trajectories [symbol] that have a small velocity variation over our small temporal window, and have a good agreement with the road network in terms of location and directionality, i.e., are coincident and co-directional with roads in the road network;
(b) Associations \hat{Ω} that temporally associate vehicle detections after mapping their locations to the coordinate system of R_{g}, in a way that have a good agreement with [symbol] ; and
(c) Alignments Â₁ that map the vehicle detections locations to the coordinate system of R_{g}.

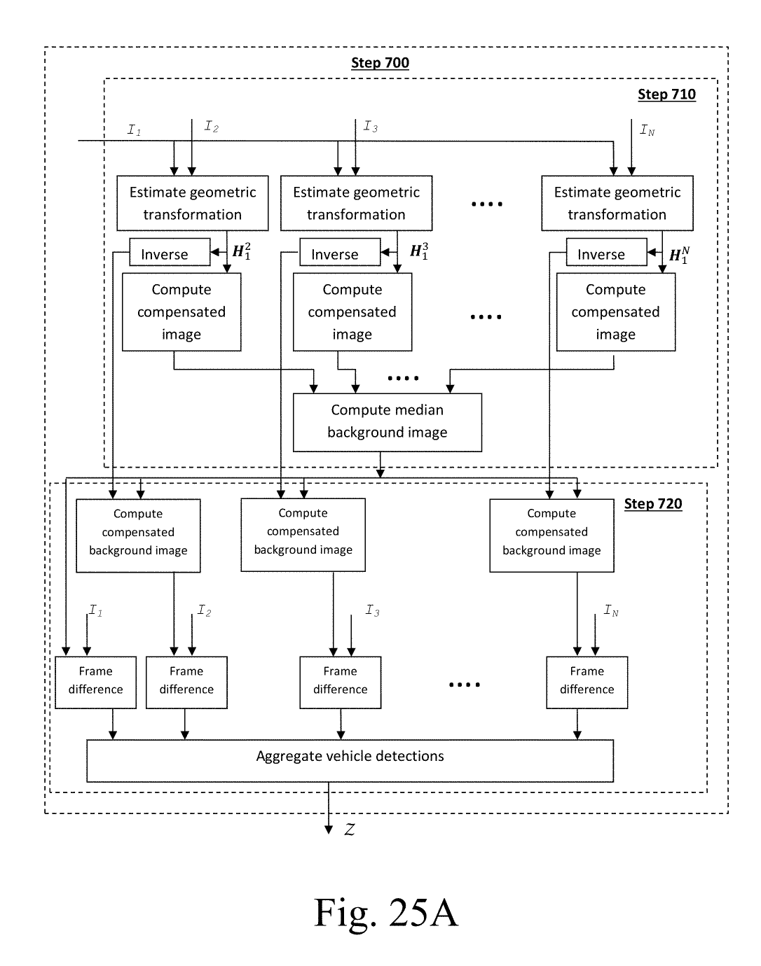

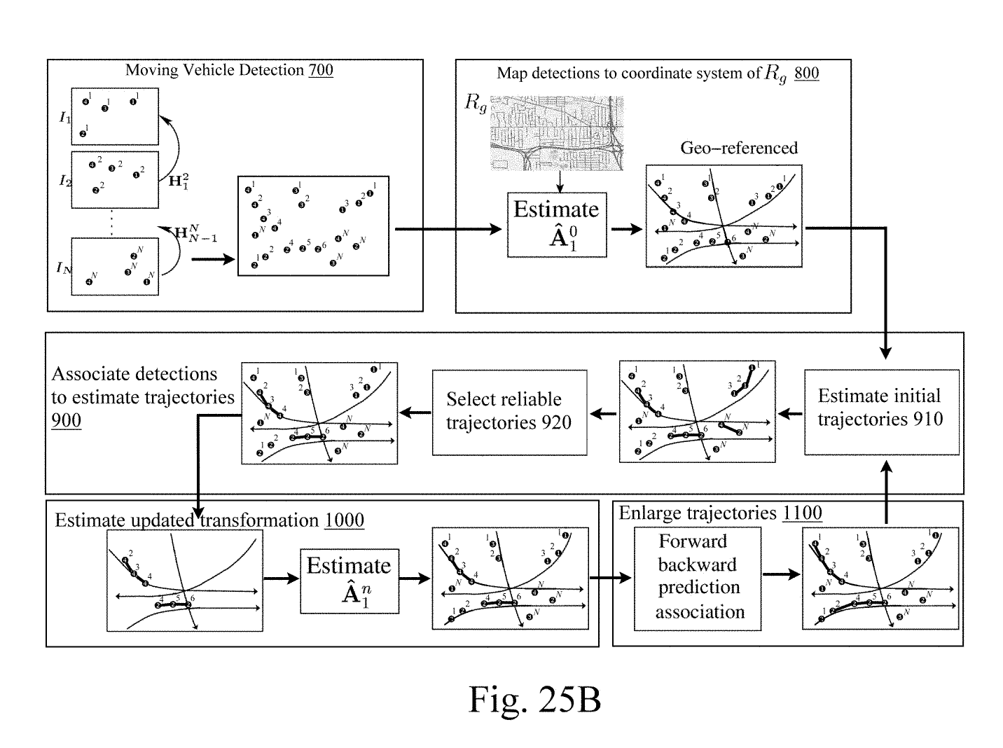

A high level overview of the third algorithm is shown in block-diagram format in FIGS. 25A-B, along with illustrative drawings. The algorithm sequentially alternates between estimating [symbol] and Â₁ to obtain a solution to satisfy, as well as reasonably possible, requirements (a), (b), and (c). In step 700, the algorithm may estimate moving vehicle locations within each frame (as defined within the coordinate system of that frame, and then aggregate moving vehicle detections in all frames within the temporal window to obtain the set of all vehicle detections [symbol] . Specifically, the algorithm may first estimate the static background of the scene 710, then detect moving vehicles within each frame by subtracting the estimated background from each frame after aligning the estimated static background with that frame 720. To estimate the static background in step 710, the algorithm may co-register all frames within the temporal window, then apply a median filter in the temporal dimension to the sequence of temporally registered values in the co-registered frames at each spatial location. Moving vehicle detection 720 is similar to step 100, but performed on a frame-by-frame basis using the estimated static background image instead of the compensated image Ĩₜ₊₁. The reader will again note that alternative methods for detecting vehicles in a scene that operate on either single or multiple image frames can also be used with the third algorithm [20-23].

Detections are mapped to a common reference frame in the coordinate system of R_{g} using an initial estimated transformation Â_{1 800}⁰. With the initial or, subsequently, an iteratively-updated estimated transformation, the geo-referenced mapped detections are associated to estimate trajectories 900. The associations may be made on a frame-to-frame basis to estimate initial trajectories 910. Then, from such initial trajectories, reliable trajectories (defined subsequently) may be selected 920. The associations use the road network information available in R_{g} to estimate updated trajectories [symbol] ⁿ in the n^{th} iteration. With updated reliable trajectories, or updated and enlarged reliable trajectories, the algorithm estimates an updated transformation Â_{1 1000}ⁿ that more accurately aligns the updated trajectories with the road network in R_{g}. The updated transformation may be used to progressively enlarge the trajectories by iteratively linking the trajectories together or with unassigned moving vehicle detections 1100. The updated transformation, with or without the use of step 1100, helps to recover more reliable trajectories [symbol] ⁿ⁺¹ in the next iteration of steps 900 and 1000, which are repeated until no more detections are assigned to the existing trajectories.

In step 800, moving vehicle detections are mapped to the coordinate system of R_{g} by minimizing the chamfer distance between them and the road network. The chamfer distance calculation must account for alignments in all N frames of the temporal window, so that in contrast to step 300 of the first algorithm the third algorithm estimates Â₁⁰ using:

$$\begin{matrix}\hat{{A}_{1}^{0}} = arg {min}_{{A}_{1}^{0}} {f}_{1} ( {A}_{1}^{0} ) & Equation ( 33 a ) \\ where & \\ {f}_{1} ( {A}_{1}^{0} ) = \frac{1}{N} {\sum }_{i = 1}^{N} {\sum }_{k = 1}^{{N}_{k}} {min}_{j , m} d ( {A}_{1}^{0} {H}_{1}^{i} {z}_{k}^{i} , {(}^{r} {𝒳}_{j}^{m} {,}^{r} {Ϛ}_{j}^{m} ) ) . & Equation ( 33 b )\end{matrix}$$

where H₁ⁱ transforms the detected vehicle location zₖⁱ from the image coordinates of the i^{th} frame of the temporal window to the image coordinates of the 1^{st} frame of the temporal window, as discussed before the introduction of Equations (22) and (23). The third algorithm may use an LM optimization framework to minimize Equation (33) and obtain an accurate estimate of Â₁⁰ in comparison to the other techniques for geo-registration discussed in the context of the first algorithm. Â₁⁰ is then used in step 900 to begin the iterating alternating optimization portion of the third algorithm.

In step 900, the third algorithm associates geo-referenced mapped moving vehicle detections ( [symbol] in view of H₁ⁱ and, for the n^{th} iteration, Â₁ⁿ⁻¹) to estimate initial trajectories 910 and then screens the initial trajectories to select reliable trajectories 920. The goal is to associate detections within the N video frames of the temporal window to form optimal trajectories [symbol] ⁿ that maximize Equation (32a). For N=2, the association problem is a bipartite graph matching problem and the Hungarian algorithm [43] may be used to solve it in polynomial time. However, for N>2, which would be used in most practical tracking applications, the detection association problem becomes combinatorial. One solution is to associate detections on frame-to-frame basis. While useful, when two detections that are not related to the same vehicle are assigned in error, that error would be propagated into succeeding frames, leading to inaccurate estimated trajectories. A preferred solution, inspired by the highest confidence first (HCF) algorithm [44], solves the detection association problem globally over the N frame temporal window while taking advantage of the efficiency of the Hungarian algorithm. Specifically, the Hungarian algorithm is applied to assign detections on a frame-to-frame basis to estimate initial trajectories. Then reliable trajectories are selected from the initial trajectories and all remaining moving vehicle detections are treated as being unassigned. The unassigned moving vehicle detections may then be used to enlarge the reliable trajectories.

In step 910, the third algorithm estimates initial trajectories [symbol] _{f}ⁿ={f [symbol] ₁ⁿ} by associating unassigned moving vehicle detections, collectively designated uⁿ, with each other or with reliable trajectories estimated in a previous iteration [symbol] ⁿ⁻¹, based on a frame-to-frame association strategy. The association forms [symbol] _{f}ⁿ by creating new trajectories from uⁿ and augmenting trajectories in [symbol] ⁿ⁻¹ with detections from uⁿ. Specifically, associations are made based on a cost metric that has proximity and road network agreement components. The proximity component penalizes differences in position between the predicted location of a trajectory and an unassigned moving vehicle detection. The road network agreement component penalizes misalignment between the road network and a trajectory after augmenting it with an unassigned detection. The optimal frame-to-frame association minimizes the cost metric for all estimated trajectories and unassigned detections using the Hungarian algorithm [43].

In step 920, the third algorithm selects reliable trajectories [symbol] ᵣⁿ from the initial trajectories [symbol] _{f}ⁿ if estimated in step 810, i.e., trajectories for which there is a high confidence that they are estimated from true correspondences. Each reliable trajectory should have a small velocity variation, a low directional chamfer distance with the road network, and at least a minimum length. The velocity variation for each trajectory in [symbol] _{f}ⁿ is computed by Equation (27), while its directional chamfer distance with the road network is computed by Equation (30). Selecting trajectories from trajectories in [symbol] _{f}ⁿ by thresholding each trajectory velocity variation, directional chamfer distance with the road network, and length provides reliable trajectories [symbol] ᵣⁿ. After estimating those reliable trajectories, we add them to the set of all estimated trajectories [symbol] ⁿ= [symbol] ⁿ⁻¹∪ [symbol] ᵣⁿ

In step 1000, the third algorithm uses the updated trajectories [symbol] ₙ to estimate an updated transformation Â₁ⁿ that more accurately aligns the updated trajectories with the road network in R_{g}, i.e., searches for the optimal transformation Â₁ⁿ that maximizes Equation (32). The algorithm may estimate the Â₁ transformation that minimizes the distances between geo-mapped moving vehicle detections and the road network in R_{g}. However, those geo-mapped detections may correspond to true or false detections, like the true detection class and false detection class discussed in the context of the second algorithm above. To minimize the effect of false detections, the third algorithm may increase the weight of the chamfer distance between a mapped detection that belongs to a trajectory and the road network in R_{g}. Specifically, the algorithm may minimize:

$${f}_{2} ( {A}_{1}^{n} ) = \frac{1}{N} {\sum }_{i = 1}^{N} {\sum }_{{z}_{k}^{i} ∈ {u}^{n}} {min}_{j , m} d ( {A}_{1}^{n} {H}_{1}^{i} {z}_{k}^{i} , {(}^{r} {𝒳}_{j}^{m} {,}^{r} {Ϛ}_{j}^{m} ) ) + α {\sum }_{{\hat{T}}_{l}^{n} ∈ {\hat{𝒯}}^{n}} \frac{1}{\vert {\hat{T}}_{l}^{n} \vert} {\sum }_{k = 1}^{\vert {\hat{T}}_{l}^{n} \vert} {min}_{j , m} d ( {( \hat{{υ}_{k}^{l}} )}_{n} , {(}^{r} {𝒳}_{j}^{m} {,}^{r} {Ϛ}_{j}^{m} ) ) + λ {\vert \hat{{(}^{υ} {θ}_{k}^{l}} )}_{n} {-}^{r} {θ}_{j}^{m} \vert . \qquad Equation ( 34 )$$

where α is the weight assigned to an associated-with-trajectory detection mismatch with the road network, and (\hat{v}ₖ^{l})ₙ is the k^{th} entry in the trajectory \hat{T}ₗⁿ with an orientation given by (^{v}\hat{θ}ₖ^{l})ₙ. By minimizing Equation (32a) the algorithm estimates the geometric transform Â₁ⁿ by exploiting the distances between the unassigned detections uⁿ with the road network while giving greater weight to detections associated with reliable trajectories. The updated transformation Â₁ⁿ may be used in the next iteration so that more unassociated detections in uⁿ can be associated with updated trajectories.

The third algorithm may progressively enlarge the estimated trajectories [symbol] ⁿ, based upon the updated transformation Â₁ⁿ, by linking more unassigned detections uⁿ to them 1100. Specifically, the algorithm may iteratively associate [symbol] ⁿ together and with unassigned detections uⁿ after mapping all detections to the coordinate system of the road network using the updated transformation Â₁ⁿ. This association problem may be solved through two pass scheme. Designating Hᵢⁿ as the set of heads for all estimated trajectories [symbol] ⁿ, which represent the first assigned detection in each trajectory that occurs in the i^{th} frame; Lᵢⁿ as the set of tails for all estimated trajectories [symbol] ⁿ, which represent the last assigned detection in each trajectory that occurs in the i^{th} frame; and uᵢⁿ as the set of unassigned moving vehicle detections which occur in the i^{th} frame, i.e. uᵢⁿ={zₖⁱ:∀Tₛ∈ [symbol] ⁿ, A₁H₁ⁱzₖⁱ∉Tₛ, ∀k}:
1. Forward pass: for the i^{th} frame within the N frame temporal window, forward extrapolate the set of tails for all estimated trajectories Lᵢⁿ that occur in the i^{th} frame, i.e., extrapolate each reliable trajectory one time instant forward from its last trajectory-associated detection location in the direction of the nearest road with the last velocity to estimate its predicted detection in the next video frame. Given all predicted detections Pᵢ₊₁^{f} at frame i+1 predicted from all estimated trajectories, use the Hungarian algorithm to associate those predicted detections with Hᵢ₊₁ⁿ in addition to the unassigned detections uᵢ₊₁ⁿ, where Hᵢ₊₁ⁿ are the head (start) detections of all estimated trajectories in frame i+1. The cost metric in the associating problem may be composed of proximity and road agreement components as discussed earlier.
2. Backward pass: for the i^{th} frame within the N frame temporal window, backward extrapolate the set of heads for all estimated trajectories Hᵢⁿ that occur in the i^{th} frame to obtain predicted detections in the previous video frame Pᵢ₋₁^{b}. Given Pᵢ₋₁^{b}, use the Hungarian algorithm to associate those predicted detections with Lᵢ₋₁ⁿ, in addition to the unassigned detections uᵢ₋₁ⁿ with a similar cost metric.

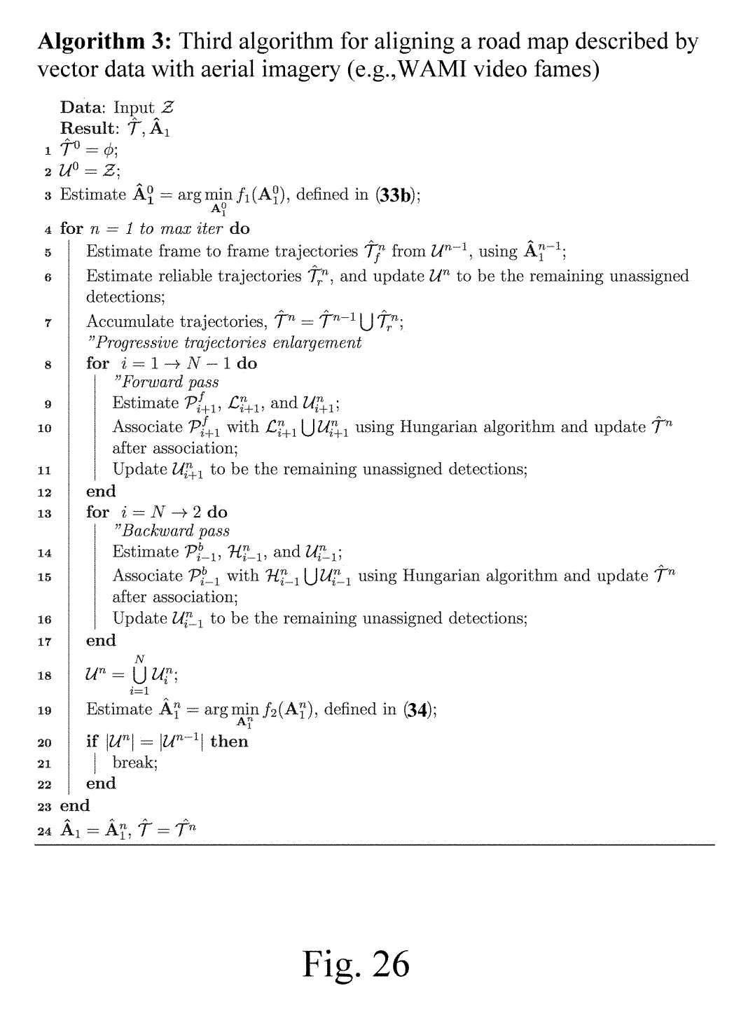

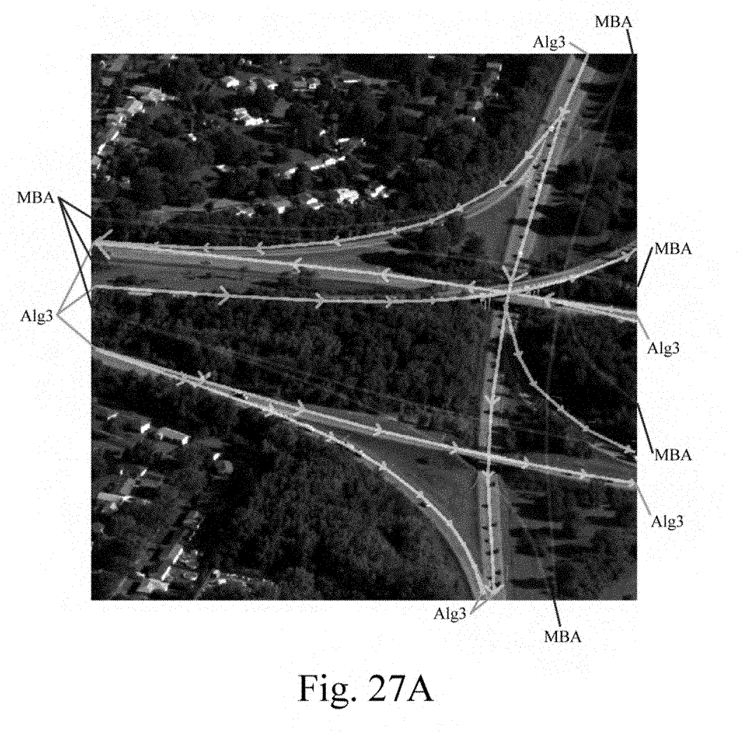

Thus, as discussed earlier, in each iteration n of steps 900 to 1000, or steps 900 to 1100, the third algorithm associates more unassigned moving vehicle detections to the estimated trajectories. Moreover, because the new position for each estimated trajectory is determined using its velocity and the nearest road segment direction, the approach can enforce a low disagreement between each estimated trajectory and the road network in R_{g} with low variation in estimated trajectory velocity. This way, the algorithm can heuristically maximize Equation (32) in a sequential fashion to obtain an estimate of both [symbol] and A₁, i.e., [symbol] and Â₁. An implementation of the third algorithm is shown in FIG. 26.

### Third Registration Algorithm Example and Results

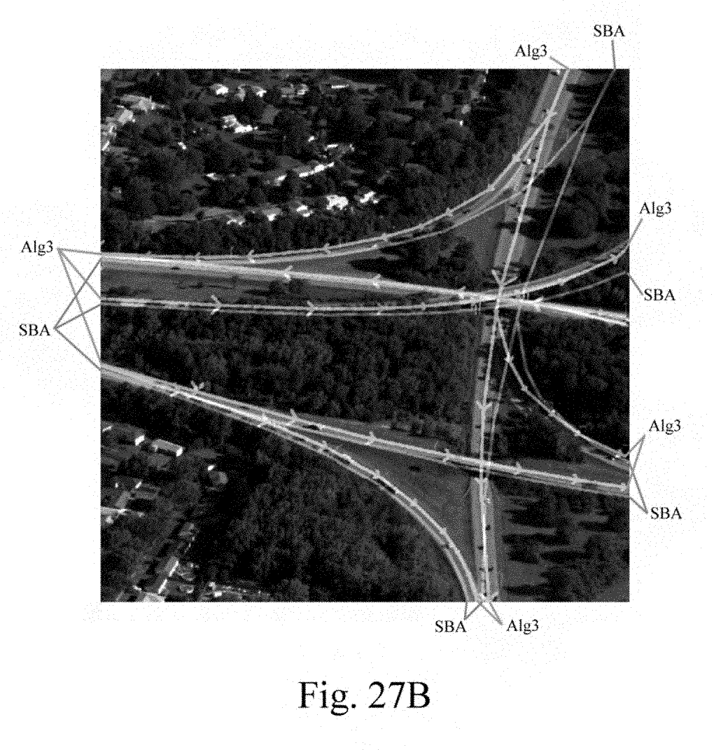

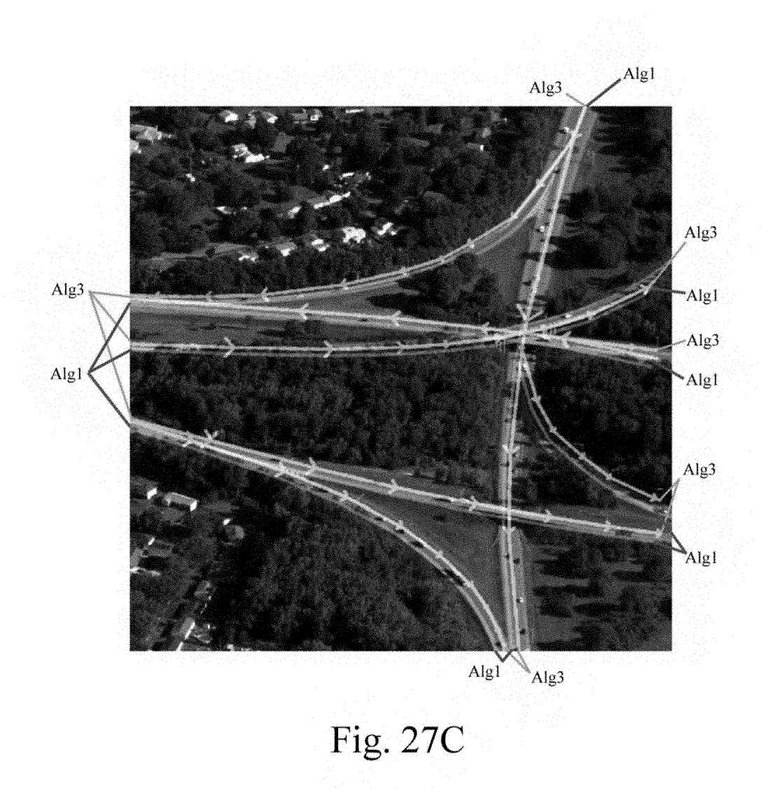

We evaluated the third algorithm on a WAMI dataset recorded using CorvusEye 1500 Wide-Area Airborne System [3] for the Rochester, N.Y. region. For the vector road map, we again used OpenStreetMap (OSM) [31]. Our WAMI video frames were each 4400×6600 pixels, and stored using NITF 2.1 format [33]. We extracted the four approximate geographical coordinates for the corners associated with each WAMI video frame, and we used these corners to estimate the initial transformation that mapped each WAMI video frame to the coordinate system of R_{g}. We created a test sequence by cropping a region (1000×1000 pixels) containing a forked road network with different directions, as well as many occluders (bridges, trees, etc.), from all WAMI video frames within a temporal window of N=10. Exemplary cropped frames are shown in FIGS. 27A-C.

First, we compared the algorithm shown in FIG. 26 with three alternative methods: the MBA method; the SBA method; and the first algorithm (Alg1). Head-to-head comparisons for the obtained alignments are shown in FIGS. 27A-C. FIG. 27A shows a significant enhancement over MBA, which depends only on the meta-data to get an aligned road network. The MBA method has significant errors because of the limited accuracy of the on-board GPS and INS systems navigation devices used to provide the meta-data parameters. FIG. 27B shows a lesser but still significant improvement over SBA, which uses SIFT and an auxiliary geo-referenced image. The SBA method does not improve significantly because of spurious correspondences found by SIFT when matching the aerial image to Google maps-sourced geo-referenced image, particularly due to severe view point change, different illumination conditions, and different image capture times between imagery. The third algorithm does not face the challenges associated with aligning images captured under these different conditions because it aligns vehicle trajectories to the road network by transforming both into a vector representation that allows for efficient computation of the directional chamfer distance as a meaningful metric. FIG. 27C shows additional improvement over the first algorithm because the algorithm uses vehicle trajectories (locations and directions) to estimate alignment with the road network, while the first algorithm estimate the alignment from moving vehicle detections only.

To provide a quantitative comparison, manually generated “ground truth” road networks for the cropped test sequence frames were compared to final alignments generated using the MBA method, the SBA method, the first algorithm, and the third algorithm using the chamfer distance metric discussed above. Table 3 shows the chamfer distance between the ground truth road network and the road network alignments generated by these alternatives. The results reinforce the conclusions seen from FIGS. 27A-C. The third algorithm has a much lower chamfer distance value highlighting the fact that the proposed method offers a significant improvement over both the MBA and SBA methods, and shows a moderate improvement over the first algorithm.

TABLE 3
Chamfer distance between the ground truth
road network and generated road network

| | MBA | SBA | Alg1 | Alg3 |
|---|---|---|---|---|
| Ground truth | 33.4 | 5.9 | 0.9 | 0.56 |
| chamfer distance | | | | |

Tracking performance was compared to two known tracking methodologies. The first, “Frame-to-Frame-based Association method (F2FA)” [13], uses the Hungarian algorithm to associate vehicle detections with estimated trajectories from frame-to-frame using a cost metric that penalizes velocity, position, and spatial context mismatch constrained by an estimated road direction. The second, “Frame-to-Frame-based Road-constrained Association method (F2FRA),” drops the road direction estimation step, and modifies F2FA to exploit the accurately aligned road network as determined by the first algorithm. The ID-switch results summarized in Table 4 are much less for the third algorithm than for the F2FA-based methods. The F2FA method is prone to ID-switches because it associates vehicle detections from frame-to-frame. Therefore, if an error occurred in such an assignment, that error propagates into successive frames. In other words, the F2FA method does not have any mechanism for correcting assignment errors made in previous frames. Introducing our aligned road network to the association cost function improves the ID-switch performance of the F2FRA-modified F2FA method, but the third algorithm still provides significantly better tracking performance. The results highlight an additional contribution of the third algorithm, which solves the multi-vehicle tracking problem globally over the entire temporal window. The HCF approach employed in the third algorithm introduces a mechanism that can recover from assignment errors resulting from frame-to-frame association errors.

TABLE 4
Chamfer distance between the ground truth
road network and generated road network

| | F2FA | F2FRA | Alg3 |
|---|---|---|---|
| ID-switches | 3.2 | 2.1 | 0.6 |
| MOTA | 0.55 | 0.7 | 0.91 |

### CONCLUSION

Our algorithms for addressing the problem of road network registration with aerial images have many benefits. First, by exploiting the vehicle detections in aerial imagery, such as WAMI video frames, we implicitly transfer the imagery to a representation that can be easily matched with the vector road network. Second, our algorithms do not depend on specific type of imaging sensor to capture imagery. In other words, the captured scenes used with the algorithms need only be processed to extract moving vehicle detections with sufficient detail, regardless of the sensor type used or image spectrum represented in the imagery. Our second algorithm, through use of an Expectation Maximization (EM) framework and classification of moving vehicle detections, gives a robustness to the final estimated alignment by handling the image contamination/noise that will almost inevitably be present in any imaging modality. Our third algorithm offers a significant improvement over prior alternative approaches that tackle the imagery alignment and vehicle tracking problems individually. Results obtained for test datasets captured using both visual and infra-red sensors show the effectiveness of the disclosed algorithms. Both visually and in terms of numerical metrics for alignment accuracy, the algorithms offer a very significant improvement over available alternatives.

It will be appreciated that claims to the algorithms may encompass processes and apparatus, including embodiments in hardware, software, or combinations thereof, such as a computer processor executing such an algorithm, a non-transient computer readable storage medium containing instructions for execution of such an algorithm by a computer processor (such a medium including, but not limited to, programs stored in volatile memory, non-volatile memory, and flash or disk-based storage media), and an aerial imaging platform (particularly a WAMI platform) executing such an algorithm. It will be appreciated that variants of the above-disclosed and other features and functions, or alternatives thereof, may be combined into many different systems or applications, including WAMI systems, low orbit satellite imagery systems, and similar systems carried on various powered and unpowered aerial platforms. Various presently unforeseen or unanticipated alternatives, modifications, variations, or improvements therein may be subsequently made by those skilled in the art which are also intended to be encompassed by the claims.

### REFERENCES

[1] K. Palaniappan, R. M. Rao, and G. Seetharaman, “Wide-area persistent airborne video: Architecture and challenges,” in Distributed Video Sensor Networks, Springer, 2011, pp. 349-371.
[2] E. Blasch, G. Seetharaman, S. Suddarth, K. Palaniappan, G. Chen, H. Ling, and A. Basharat, “Summary of methods in wide-area motion imagery (WAMI),” in Proc. SPIE, vol. 9089, 2014, pp. 90 890C-90 890C-10.
[3] “CorvusEye™1500,” http://www.exelisinc.com/solutions/corvuseye1500/Pages/default.aspx.
[4] D. G. Lowe, “Distinctive image features from scale-invariant keypoints,” Intl. J. Computer Vision, vol. 60, no. 2, pp. 91-110, 2004.
[5] W. Song, J. Keller, T. Haithcoat, and C. Davis, “Automated geospatial conflation of vector road maps to high resolution imagery,” IEEE Trans. Image Proc., vol. 18, no. 2, pp. 388-400, February 2009.
[6] C.-C. Chen, C. A. Knoblock, and C. Shahabi, “Automatically conflating road vector data with orthoimagery,” GeoInformatica, vol. 10, no. 4, pp. 495-530, 2006.
[7] C.-C. Chen, C. A. Knoblock, C. Shahabi, Y.-Y. Chiang, and S. Thakkar, “Automatically and accurately conflating orthoimagery and street maps,” in Proc. ACM Int. Workshop on Geographic Information Systems. ACM, 2004, pp. 47-56.
[8] J. Xiao, H. Cheng, H. Sawhney, and F. Han, “Vehicle detection and tracking in wide field-of-view aerial video,” in IEEE Intl. Conf. Comp. Vision, and Pattern Recog., June 2010, pp. 679-684.
[9] J. Xiao, H. Cheng, F. Han, and H. Sawhney, “Geo-spatial aerial video processing for scene understanding and object tracking,” in IEEE Intl. Conf. Comp. Vision, and Pattern Recog., June 2008, pp. 1-8.
[10] H. Bay, A. Ess, T. Tuytelaars, and L. Van Gool, “Speeded-up robust features (SURF),” Comp. Vis. and Image Understanding., vol. 110, no. 3, pp. 346-359, June 2008.
[11] M. A. Fischler and R. C. Bolles, “Random sample consensus: a paradigm for model fitting with applications to image analysis and automated cartography,” Commun. ACM, vol. 24, no. 6, pp. 381-395, 1981.
[12] R. Hartley and A. [symbol] isserman, Multiple View Geometry in Computer Vision, 2nd ed. New York, N.Y., USA: Cambridge University Press, 2003.
[13] V. Reilly, H. Idrees, and M. Shah, “Detection and tracking of large number of targets in wide area surveillance,” in Proc. European Conf. Computer Vision, 2010, vol. 6313, pp. 186-199.
[14] X. Shi, P. Li, H. Ling, W. Hu, and E. Blasch, “Using maximum consistency context for multiple target association in wide area traffic scenes,” in IEEE Intl. Conf. Acoust., Speech, and Signal Proc., May 2013, pp. 2188-2192.
[15] A. Dehghan, S. M. Assari, and M. Shah, “GMNICP tracker: Globally optimal generalized maximum multi clique problem for multiple object tracking,” in IEEE Intl. Conf. Comp. Vision, and Pattern Recog., 2015, pp. 4091-4099.
[16] A. R. [symbol] amir, A. Dehghan, and M. Shah, “GMCP-tracker: Global multi-object tracking using generalized minimum clique graphs,” in Proc. European Conf. Computer Vision., 2012, pp. 343-356.
[17] A. Andriyenko, K. Schindler, and S. Roth, “Discrete-continuous optimization for multi-target tracking,” in IEEE Intl. Conf. Comp. Vision, and Pattern Recog., 2012, pp. 1926-1933.
[18] H. G. Barrow, J. M. Tenenbaum, R. C. Bolles, and H. C. Wolf, “Parametric correspondence and chamfer matching: Two new techniques for image matching,” in Proc. Int. Joint Conf. Artificial Intell., 1977, pp. 659-663.
[19] A. M. Tekalp, Digital Video Processing. Upper Saddle River, N.J., USA: Prentice-Hall, Inc., 1995.
[20] M. Teutsh and W. Kruger, “Robust and fast detection of moving vehicles in aerial videos using sliding windows,” in IEEE Intl. Conf. Comp. Vision, and Pattern Recog. Workshops, June 2015.
[21] H. Grabner, T. T. Nguyen, B. Gruber, and H. Bishof, “On-line boosting-based car detection from aerial images,” ISPRS, vol. 63, no. 3, pp. 382-396, 2008.
[22] K. Palaniappan, F. Bunyak, P. Kumar, I. Ersoy, S. Jaeger, K. Ganguli, A. Haridas, J. Fraser, R. Rao, and G. Seetharaman, “Efficient feature extraction and likelihood fusion for vehicle tracking in low frame rate airborne video,” in Intl. Conf. on Info. Fusion, July 2010, pp. 1-8.
[23] X. Shi, H. Ling, E. Blasch, and W. Hu, “Context-driven moving vehicle detection in wide area motion imagery,” in IEEE Intl. Conf. on Pattern Recog., November 2012, pp. 2512-2515.
[24] E. Rosten and T. Drummond, “Machine learning for high-speed corner detection,” in Proc. European Conf. Computer Vision, ser. Lecture Notes in Computer Science, 2006, vol. 3951, pp. 430-443.
[25] E. Rublee, V. Rabaud, K. Konolige, and G. Bradski, “ORB: An efficient alternative to SIFT or SURF,” in IEEE Intl. Conf Comp. Vision., November 2011, pp. 2564-2571.
[26] A. Alahi, R. Ortiz, and P. Vandergheynst, “FREAK: Fast retina keypoint,” in IEEE Intl. Conf. Comp. Vision, and Pattern Recog., June 2012, pp. 510-517.
[27] Shah, Mubarak, and Rakesh Kumar. “Video Registration: A Perspective.” Video Registration. Springer US, 2003.1-17
[28] J. D. Foley, R. L. Phillips, J. F. Hughes, A. v. Dam, and S. K. Feiner, Introduction to Computer Graphics. Boston, Mass., USA: Addison-Wesley Longman Publishing Co., Inc., 1994.
[29] G. Borgefors, “Distance transformations in digital images,” Comp. Vis., Graphics and Image Proc., vol. 34, no. 3, pp. 344-371, June 1986.
[30] J. Nocedal and S. J. Wright, Numerical Optimization, 2nd ed. New York: Springer, 2006.
[31] “OpenStreetMap,” http://www.openstreetmap.org.
[32] M. F. Goodchild, “Citizens as voluntary sensors: spatial data infrastructure in the world of web 2.0,” Intl. J. of Spatial Data Infrastructures Research, vol. 2, pp. 24-32, 2007.
[33] NITFS baseline documents. [Online]. Available: http://www.gwg.nga.mil/ntb/baseline/index.html
[34] OpenCV library. [Online]. Available: http://opencv.org/[35]P. H. Torr and A. [symbol] isserman, “Mlesac: A new robust estimator with application to estimating image geometry,” Comp. Vis. and Image Understanding., vol. 78, no. 1, pp. 138-156, 2000.
[36] R. Horaud, F. Forbes, M. Yguel, G. Dewaele, and J. [symbol] hang, “Rigid and articulated point registration with expectation conditional maximization,” IEEE Trans. Pattern Anal. Mach. Intel., vol. 33, no. 3, pp. 587-602, 2011.
[37] J. Ma, H. [symbol] hou, J. [symbol] hao, Y. Gao, J. Jiang, and J. Tian, “Robust feature matching for remote sensing image registration via locally linear transforming,” IEEE Trans. Geosci. and Remote Sensing, vol. 53, no. 12, pp. 6469-6481, 2015.
[38] C. M. Bishop, Pattern Recognition and Machine Learning. Springer, 2006.
[39] J. P. Snyder, Map projections—A working manual, US Government Printing Office, 1987, vol. 1395.
[40] AFRL WPAFB 2009 data set, https://www.sdms.afrl.afmil.
[41] M.-Y. Liu, O. Tuzel, A. Veeraraghavan, and R. Chellappa, “Fast directional chamfer matching,” in IEEE Intl. Conf. Comp. Vision, and Pattern Recog., June 2010, pp. 1696-1703.
[42] T. M. Cover and J. A. Thomas, Elements of Information Theory, 2nd ed., New York: John Wiley and Sons, 2006.
[43] H. W. Kuhn, “The hungarian method for the assignment problem,” Naval Res. Logistics Quart., vol. 2, no. 1-2, 1955, pp. 83-97.
[44] R. Kasturi, D. Goldgof, P. Soundararaj an, V. Manohar, J. Garofolo, R. Bowers, M. Boonstra, V. Korzhova, and J. [symbol] hang, “Framework for performance evaluation of face, text, and vehicle detection and tracking in video: Data, metrics, and protocol,” IEEE Trans. Pattern Anal. Mach. Intel., vol. 31, no. 2, February 2009, pp. 319-336.

What is claimed is:

1. A method for aligning one or more images, captured by a camera on an aerial imaging platform, with a road network, described by geo-referenced data as binary images, vector data, or other representation, the method comprising:
identifying locations of moving vehicles in at least one of the images;
estimating a coordinate transformation that aligns the identified locations with the road network described by the geo-referenced data; and
outputting the estimated coordinate transformation or applying the estimated coordinate transformation to at least one of the images to align the image(s) with the road network described by the geo-referenced data.

2. The method of claim 1, where the locations of moving vehicles are identified from the images by computing differences between the images after compensating for global changes between the images caused by a change in the position or orientation of the camera.

3. The method of claim 1, wherein the estimating step includes minimization of an objective function based upon a chamfer distance between identified locations of moving vehicles and the road network described by the geo-referenced data.

4. The method of claim 1, wherein the estimated coordinate transformation comprises a planar homography.

5. A method for aligning a series of images, captured by a camera on an aerial imaging platform, with a road network described by geo-referenced vector data, the method comprising:
aligning the series of images to the road network described by geo-referenced vector data by estimating a series of coordinate transformations that align moving vehicle locations detected within the series of images with the road network;
applying the estimated coordinate transformations to the detected moving vehicle locations;
classifying the post-transformation detected moving vehicle locations, as on-road vehicle locations or non-on-road vehicle locations, by comparing the post-transformation detected moving vehicle locations to the road network; and
realigning the series of images to the road network by estimating a series of coordinate transformations that align the on-road-vehicle-location-classified locations with the road network described by geo-referenced vector data.

6. A method for aligning a series of images, captured by a camera on an aerial imaging platform, with a road map describing a road network via geo-referenced data, as binary images, vector data, or other representation, and for tracking on-road moving vehicles in the imaged scene, the method comprising:
estimating an initial set of moving vehicle detections corresponding to putative vehicle locations in the imaged scene;
estimating an initial set of parameters specifying an alignment between the road map and the series of images; and
iteratively performing, at least once, the following:
estimating identifiable parts of trajectories of one or more on-road vehicles by associating members a temporal sequence of locations, corresponding to vehicle detections not yet assigned to an existing reliable trajectory, with other such members or with an existing reliable trajectory based upon an alignment to the road map specified by the set of parameters;
selecting estimated trajectories based upon at least one of: proximity to a road in the road map; co-directionality with a road in the road map; and speed of travel; whereupon the selected estimated trajectories are added to existing reliable trajectories; and
updating the set of parameters to improve a measure of coincidence between the existing reliable trajectories and the roads in the roadmap, wherein the measure of coincidence is based on estimating the proximity of the existing reliable vehicle trajectories to roads in the road map and, optionally, co-directionality with roads in the road map.

7. The method of claim 6 wherein the iteratively performed steps further include:
enlarging the existing reliable trajectories by associating members of the temporal sequence of locations, corresponding to vehicle detections not yet assigned to the existing reliable trajectories, with the existing reliable trajectories based upon the updated set of parameters and proximity to temporal locations extrapolated from the existing reliable trajectories, whereupon the enlarged reliable trajectories are added to the existing reliable trajectories.

8. The method of claim 6 wherein the measure of coincidence is a chamfer distance, computed using a distance transform, between the existing reliable trajectories and the roads in the road map.

9. The method of claim 8, wherein the chamfer distance is a directional chamfer distance measuring both coincidence and co-directionality between the existing reliable trajectories and the roads in the road map.
